(19) United States
(12) Patent Application Publication
(10) Pub. No.: US 2026/0238993 A1
(43) Pub. Date: Aug. 13, 2026

(54) METHOD FOR REPORTING SENSING CAPABILITY, RECEIVING METHOD, APPARATUS, COMMUNICATION DEVICE, AND MEDIUM

(71) Applicant: VIVO MOBILE COMMUNICATION CO., LTD., Guangdong (CN)

(72) Inventors: Yannan YUAN, Guangdong (CN); Shengli DING, Guangdong (CN)

(73) Assignee: VIVO MOBILE COMMUNICATION CO., LTD., Guangdong (CN)

(21) Appl. No.: 19/470,744

(22) PCT Filed: Apr. 2, 2024
(86) PCT No.: PCT/CN2024/085560

§ 371 Date: Sep. 29, 2025

(30) Foreign Application Priority Data
Apr. 3, 2023 (CN) 202310348338.5

(51) Int. Cl. H04W 8/24

(52) U.S. Cl. CPC H04W 8/24

(57) ABSTRACT

A method for reporting sensing capability, a receiving method, an apparatus, a communication device, and a medium. The method includes: reporting sensing capability information of a first device, where the sensing capability information includes at least one of the following capabilities: whether a sensing protocol is supported, whether receiving sensing service notification is supported, whether performing sensing through a first-device-to-first-device interface is supported, whether monostatic sensing is supported, whether sensing through a first-device-to-second-device interface is supported, whether sending a sensing signal is supported, whether receiving or measuring a sensing signal is supported, whether providing sensing assistance information is supported, sensing data processing, whether a target sensing mode is supported, whether performing sensing based on at least two target RATs is supported, whether receiving a sensing request of a target device is supported.

### CROSS-REFERENCE TO RELATED APPLICATIONS

This application is the U.S. national phase of PCT Application No. PCT/CN2024/085560 filed on Apr. 2, 2024, which claims priority to Chinese Patent Application No. 202310348338.5 filed on Apr. 3, 2023, which are incorporated herein by reference in their entireties.

### TECHNICAL FIELD

This application pertains to the field of wireless communication technologies, and specifically relates to a method for reporting sensing capability, a receiving method, an apparatus, a communication device, and a medium.

### BACKGROUND

In the relevant protocol standards, the communication-related non-access stratum (NAS) capability and positioning capability of a user equipment (UE, which may also be referred to as a terminal) are defined through the UE network capability, without involving the sensing capability of the UE. In addition, for communications, the main role of a base station in the user plane (UP) is forwarding, so the relevant protocols do not define the capability of the base station. For sensing, the base station may also transmit a sensing signal, receive a sensing signal and measure sensing information, or provide sensing assistance information. Therefore, in order to select an appropriate base station or UE to participate in sensing, it is necessary to define and interact with the sensing capability of the base station or UE.

### SUMMARY

Embodiments of this application provide a method for reporting sensing capability, a receiving method, an apparatus, a communication device, and a medium.

According to a first aspect, a method for reporting sensing capability is provided and includes:
reporting, by a first device, sensing capability information of the first device;
where the sensing capability information is used to indicate at least one of the following:
capability of whether a sensing protocol is supported;
capability of whether receiving sensing service notification is supported;
capability of whether sensing through a first-device-to-first-device interface is supported;
capability of whether monostatic sensing is supported;
capability of whether sensing through a first-device-to-second-device interface is supported, the second device being of a different type from the first device;
capability of whether sending a sensing signal is supported;
capability of whether receiving or measuring a sensing signal is supported;
capability of whether providing sensing assistance information is supported;
sensing data processing capability;
capability of whether a target sensing mode is supported;
capability of whether sensing based on at least two target radio access technologies is supported;
capability of whether receiving a sensing request sent by a target device is supported;
capability of whether an application function selecting the first device to participate in sensing is supported;
capability of whether a target sensing scrambling algorithm is supported;
capability of whether a target sensing fuzzification algorithm is supported;
supported sensing resolution;
supported sensing accuracy; and
supported sensing service range.

According to a second aspect, a method for receiving sensing capability is provided and includes:
receiving, by a third device, sensing capability information of a first device;
where the sensing capability information is used to indicate at least one of the following:
capability of whether a sensing protocol is supported;
capability of whether receiving sensing service notification is supported;
capability of whether sensing through a first-device-to-first-device interface is supported;
capability of whether monostatic sensing is supported;
capability of whether sensing through a first-device-to-second-device interface is supported, the second device being of a different type from the first device;
capability of whether sending a sensing signal is supported;
capability of whether receiving or measuring a sensing signal is supported;
capability of whether providing sensing assistance information is supported;
sensing data processing capability;
capability of whether a target sensing mode is supported;
capability of whether sensing based on at least two target radio access technologies is supported;
capability of whether receiving a sensing request sent by a target device is supported;
capability of whether an application function selecting the first device to participate in sensing is supported;
capability of whether a target sensing scrambling algorithm is supported;
capability of whether a target sensing fuzzification algorithm is supported;
supported sensing resolution;
supported sensing accuracy; and
supported sensing service range.

According to a third aspect, an apparatus for reporting sensing capability is provided and includes:
a reporting module, configured to report sensing capability information of a first device;
where the sensing capability information is used to indicate at least one of the following:
capability of whether a sensing protocol is supported;
capability of whether receiving sensing service notification is supported;
capability of whether sensing through a first-device-to-first-device interface is supported;
capability of whether monostatic sensing is supported;
capability of whether sensing through a first-device-to-second-device interface is supported, the second device being of a different type from the first device;
capability of whether sending a sensing signal is supported;
capability of whether receiving or measuring a sensing signal is supported;
capability of whether providing sensing assistance information is supported;
sensing data processing capability;
capability of whether a target sensing mode is supported;
capability of whether sensing based on at least two target radio access technologies is supported;
capability of whether receiving a sensing request sent by a target device is supported;
capability of whether an application function selecting the first device to participate in sensing is supported;
capability of whether a target sensing scrambling algorithm is supported;
capability of whether a target sensing fuzzification algorithm is supported;
supported sensing resolution;
supported sensing accuracy; and
supported sensing service range.

According to a fourth aspect, an apparatus for receiving sensing capability is provided and includes:
a receiving module configured to receive sensing capability information of a first device;
where the sensing capability information is used to indicate at least one of the following:
capability of whether a sensing protocol is supported;
capability of whether receiving sensing service notification is supported;
capability of whether sensing through a first-device-to-first-device interface is supported;
capability of whether monostatic sensing is supported;
capability of whether sensing through a first-device-to-second-device interface is supported, the second device being of a different type from the first device;
capability of whether sending a sensing signal is supported;
capability of whether receiving or measuring a sensing signal is supported;
capability of whether providing sensing assistance information is supported;
sensing data processing capability;
capability of whether a target sensing mode is supported;
capability of whether sensing based on at least two target radio access technologies is supported;
capability of whether receiving a sensing request sent by a target device is supported;
capability of whether an application function selecting the first device to participate in sensing is supported;
capability of whether a target sensing scrambling algorithm is supported;
capability of whether a target sensing fuzzification algorithm is supported;
supported sensing resolution;
supported sensing accuracy; and
supported sensing service range.

According to a fifth aspect, a communication device is provided, where the communication device includes a processor and a memory, the memory stores a program or instructions executable on the processor, and the program or instructions, when executed by the processor, implement the steps of the method according to the first aspect, or the program or instructions, when executed by the processor, implement the steps of the method according to the second aspect.

According to a sixth aspect, a communication device is provided and includes a processor and a communication interface, where the communication interface is configured to report sensing capability information of a first device;
where the sensing capability information is used to indicate at least one of the following:
capability of whether a sensing protocol is supported;
capability of whether receiving sensing service notification is supported;
capability of whether sensing through a first-device-to-first-device interface is supported;
capability of whether monostatic sensing is supported;
capability of whether sensing through a first-device-to-second-device interface is supported, the second device being of a different type from the first device;
capability of whether sending a sensing signal is supported;
capability of whether receiving or measuring a sensing signal is supported;
capability of whether providing sensing assistance information is supported;
sensing data processing capability;
capability of whether a target sensing mode is supported;
capability of whether sensing based on at least two target radio access technologies is supported;
capability of whether receiving a sensing request sent by a target device is supported;
capability of whether an application function selecting the first device to participate in sensing is supported;
capability of whether a target sensing scrambling algorithm is supported;
capability of whether a target sensing fuzzification algorithm is supported;
supported sensing resolution;
supported sensing accuracy; and
supported sensing service range.

According to a seventh aspect, a communication device is provided and includes a processor and a communication interface, where the communication interface is configured to receive sensing capability information of a first device;
where the sensing capability information is used to indicate at least one of the following:
capability of whether a sensing protocol is supported;
capability of whether receiving sensing service notification is supported;
capability of whether sensing through a first-device-to-first-device interface is supported;
capability of whether monostatic sensing is supported;
capability of whether sensing through a first-device-to-second-device interface is supported, the second device being of a different type from the first device;
capability of whether sending a sensing signal is supported;
capability of whether receiving or measuring a sensing signal is supported;
capability of whether providing sensing assistance information is supported;
sensing data processing capability;
capability of whether a target sensing mode is supported;
capability of whether sensing based on at least two target radio access technologies is supported;
capability of whether receiving a sensing request sent by a target device is supported;
capability of whether an application function selecting the first device to participate in sensing is supported;
capability of whether a target sensing scrambling algorithm is supported;
capability of whether a target sensing fuzzification algorithm is supported;
supported sensing resolution;
supported sensing accuracy; and
supported sensing service range.

According to an eighth aspect, a readable storage medium is provided, where the readable storage medium stores a program or instructions, the program or instructions, when executed by a processor, implement the steps of the method according to the first aspect, or the program or instructions, when executed by a processor, implement the steps of the method according to the second aspect.

According to a ninth aspect, a wireless communication system is provided and includes: a first device and a third device, where the first device is configured to perform the steps of the method according to the first aspect, and the third device is configured to perform the steps of the method according to the second aspect.

According to a tenth aspect, a chip is provided, where the chip includes a processor and a communication interface, the communication interface being coupled to the processor, and the processor being configured to run a program or instructions to implement the method according to the first aspect or to implement the method according to the second aspect.

According to an eleventh aspect, a computer program/program product is provided, where the computer program/program product is stored in a storage medium, the computer program/program product is executed by at least one processor to implement the steps of the method according to the first aspect, or the computer program/program product is executed by at least one processor to implement the steps of the method according to the second aspect.

### BRIEF DESCRIPTION OF DRAWINGS

FIG. 1 is a block diagram of a wireless communication system to which embodiments of this application are applicable;

FIG. 2 is a schematic flowchart of a method for reporting sensing capability according to an embodiment of this application;

FIG. 3 is a schematic diagram of a potential option 1 of a sensing protocol stack between a UE and a network function according to an embodiment of this application;

FIG. 4 is a schematic diagram of a potential option 2 of a sensing protocol stack between a UE and a network function according to an embodiment of this application;

FIG. 5 is a schematic diagram of a potential option 3 of a sensing protocol stack between a UE and a network function according to an embodiment of this application;

FIG. 6 is a schematic flowchart of a method for receiving sensing capability according to an embodiment of this application;

FIG. 7 is a schematic diagram of 5G mobility management capability information parameters according to an embodiment of this application;

FIG. 8 is a schematic diagram of 5G mobility management capability information parameters according to another embodiment of this application;

FIG. 9 is a schematic diagram of 5G mobility management capability information parameters according to yet another embodiment of this application;

FIG. 10 is a schematic structural diagram of an apparatus for reporting sensing capability according to an embodiment of this application;

FIG. 11 is a schematic structural diagram of a method for receiving sensing capability according to an embodiment of this application;

FIG. 12 is a schematic structural diagram of a communication device according to an embodiment of this application;

FIG. 13 is a schematic hardware structural diagram of a terminal according to an embodiment of this application;

FIG. 14 is a first schematic hardware structural diagrams of a network-side device according to an embodiment of this application; and

FIG. 15 is a second schematic hardware structural diagram of a network-side device according to an embodiment of this application.

### DETAILED DESCRIPTION

The following clearly describes the technical solutions in embodiments of this application with reference to the accompanying drawings in the embodiments of this application. Apparently, the described embodiments are only some rather than all of the embodiments of this application.

The terms “first”, “second”, and the like in this application are used to distinguish between similar objects instead of describing a specific order or sequence. It should be understood that terms used in this way are interchangeable in appropriate circumstances so that the embodiments of this application can be implemented in other orders than the order illustrated or described herein. Moreover, “first” and “second” are usually used to distinguish objects of a same type, and do not restrict a quantity of objects. For example, there may be one or a plurality of first objects. In addition, “or” in this application indicates at least one of the connected objects. For example, “A or B” encompasses three scenarios: scenario one, including A but not B; scenario two, including B but not A; and scenario three, including both A and B. The character “/” generally indicates an “or” relationship between the associated objects before and after the character.

The term “indication” in this application may be either a direct indication (or explicit indication) or an indirect indication (or implicit indication). The direct indication can be understood as the sender explicitly informing the receiver of specific information, operations to be performed, or request results in the sent indication; and the indirect indication can be understood as the receiver determining the corresponding information based on the indication sent by the sender, or making a judgment and determining the operations to be performed or request results based on the judgment result.

It should be noted that technologies described in the embodiments of this application are not limited to a long term evolution (LTE)/LTE-Advanced (LTE-A) system, and may also be applied to other wireless communication systems, for example, code division multiple access (CDMA), time division multiple access (TDMA), frequency division multiple access (FDMA), orthogonal frequency division multiple access (OFDMA), single-carrier frequency division multiple access (SC-FDMA), or other systems. The terms “system” and “network” in the embodiments of this application are often used interchangeably, and the technology described herein may be used in the above-mentioned systems and radio technologies as well as other systems and radio technologies. In the following descriptions, a new radio (NR) system is described for an illustration purpose, and NR terms are used in most of the following descriptions, although these technologies may also be applied to other systems than an NR system, for example, the 6th generation (6G) communication system.

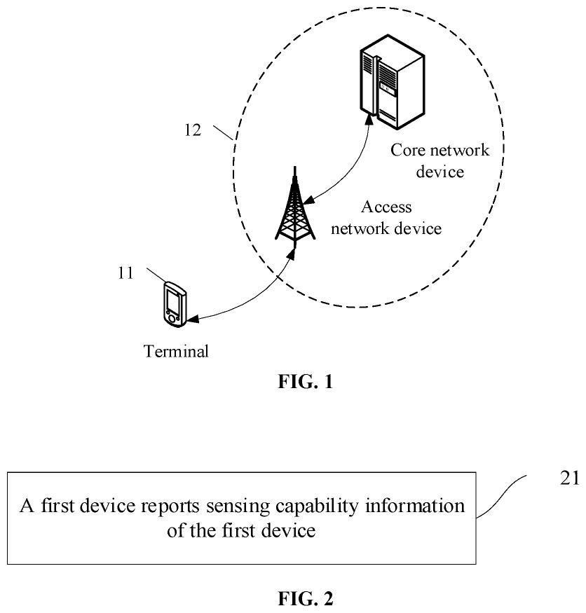

FIG. 1 is a block diagram of a wireless communication system to which embodiments of this application are applicable. The wireless communication system includes a terminal 11 and a network-side device 12. The terminal 11 may be a terminal-side device such as a mobile phone, a tablet personal computer (Tablet Personal Computer), a laptop computer (Laptop Computer), a notebook computer, a personal digital assistant (PDA), a palmtop computer, a netbook, an ultra-mobile personal computer (UMPC), a mobile internet device (MID), augmented reality (AR), virtual reality (VR) equipment, a robot, a wearable device (Wearable Device), a flight vehicle (flight vehicle), a vehicle user equipment (VUE), a shipborne equipment, a pedestrian user equipment (PUE), a smart home (home equipment with wireless communication functions, such as refrigerators, televisions, washing machines or furniture), a game console, a personal computer (PC), a teller machine, or a self-service machine. The wearable device includes a smart watch, a smart band, smart earphones, smart glasses, smart jewelry (a smart bracelet, a smart chain bracelet, a smart ring, a smart necklace, a smart anklet, a smart chain anklet, or the like), a smart wrist band, smart clothing, or the like. The vehicle user equipment may also be referred to as a vehicle terminal, a vehicle controller, a vehicle module, a vehicle component, a vehicle chip, or a vehicle unit. It should be noted that the specific type of the terminal 11 is not limited in the embodiments of this application. The network-side device 12 may include an access network device or a core network device, where the access network device may also be referred to as a radio access network (RAN) device, a radio access network function, or a radio access network unit. The access network device may include a base station, a wireless local area network (WLAN) access point (AP) or a wireless fidelity (Wi-Fi) node. The base station may be referred to as a node B (NB), an evolved node B (eNB), a next generation node B (gNB), a new radio node B NR Node B), an access point, a relay base station (RBS), a serving base station (SBS), a base transceiver station (BTS), a radio base station, a radio transceiver, a basic service set (BSS), an extended service set (ESS), a home node B (HNB), a home evolved node B (home evolved Node B), a transmission reception point (TRP), or some other suitable terms in the field, as long as the same technical effect is achieved, and the base station is not limited to a specific technical vocabulary. It should be noted that in the embodiments of this application, only the base station in the NR system is taken as an example for introduction, and the specific type of the base station is not limited.

The core network device may include but is not limited to at least one of the following: a core network node, a core network function, a mobility management entity (MME), an access management function (AMF), a session management function (SMF), a user plane function (UPF), a policy control function (PCF), a policy and charging rules function (PCRF) unit, an edge application server discovery function (EASDF), unified data management (UDM), a unified data repository (UDR), a home subscriber server (HSS), a centralized network configuration (CNC), a network repository function (NRF), a network exposure function (NEF), a local NEF (L-NEF), a binding support function (BSF), and an application function (AF). It should be noted that the embodiments of this application are described with only the core network device in the NR system as an example, but the core network device is not limited to any specific type.

The technical content involved in this application is briefly described below.

### 1. Communication and Sensing Integration

Communication and sensing integration means realizing an integrated design of communication and sensing functions through spectrum sharing and hardware sharing in the same system. While sending and receiving information, the system can sense information such as position, distance, or speed, and detect, track or identify target devices or events. The communication system and the sensing system complement each other to achieve overall performance improvement and bring better service experience.

Future mobile communication systems such as beyond 5G (B5G) mobile communication systems or sixth generation (6G) mobile communication systems will have sensing capabilities in addition to communication capabilities. Sensing capability means that one or more devices with sensing capabilities can sense information such as position, distance, or speed of a target object through the sending and reception of wireless signals, or detect, track, identify, or image the target object, event, or environment. In the future, with the deployment of small base stations with high-frequency large-bandwidth capabilities such as millimeter waves and terahertz in 6G networks, the sensing resolution will be significantly improved compared to centimeter waves, thereby enabling 6G networks to provide precise sensing services. Typical sensing functions and application scenarios are shown in Table 1.

TABLE 1

| Communication | | |
|---|---|---|
| sensing category | Sensing function | Application scenario |
| Macro sensing | Weather conditions, air quality, or | Meteorology, agriculture, or |
| class | the like | life service |
| | Traffic flow (intersection) or people | Intelligent transportation or |
| | flow (subway entrance) | commercial service |
| | Target tracking, ranging, speed | Many application scenarios |
| | measurement, shape contour, or the | of traditional radar |
| | like | |
| | Environment reconstruction | Intelligent driving and |
| | | navigation |
| | | (automobile/drone), smart |
| | | city (3D map) or network |
| | | planning and optimization |
| Fine sensing | Action/posture/expression | Intelligent interaction, game |
| class | recognition | or smart home of smartphone |
| | Heartbeat/respiration, or the like | Health, medical care |
| | Imaging, material detection, | Security inspection, industry, |
| | component analysis, or the like | biomedicine, or the like |

The expressions of the quality of service requirements of the above sensing services are different, for example, sensing such as intelligent transportation or high-precision maps is usually expressed in terms of sensing range, distance resolution, angle resolution, speed resolution, or delay; flight intrusion detection sensing is usually expressed in terms of coverage height, sensing accuracy, or sensing delay; breathing monitoring is expressed in terms of sensing distance, sensing real-time, sensing resolution, or sensing accuracy; indoor intrusion detection is expressed in terms of sensing distance, sensing real-time, detection probability, or false alarm probability; and gesture/posture recognition is expressed in terms of sensing distance, sensing real-time, or sensing accuracy.

The service request methods of the above sensing services are different, for example, a service request based on a static area, which expresses the geographic location area of the content to be sensed in a certain coordinate system; for example, a service request based on a dynamic area, which expresses the geographic location range of the content to be sensed in M meters around a certain UE; when the range around a certain UE is relatively small, the sensing target of the area has a tight coupling relationship with the UE, for example, gesture recognition in a range of 0.2 meters around a certain UE; and for example, a continuous sensing service request for a certain dynamic target, which expresses the sensing target of the content to be sensed with a detected and continuously position-tracked target.

### 2. UE Capability

The UE capability (UE capability) of the 5G network in the related art includes UE network capability (UE network capability, also referred to as UE mobility management core network capability, UE MM Core Network Capability in the protocol) and UE radio capability. The UE 5G network capability includes: 5G mobility management capability (5GMM Capability), UE security capability (UE security capability), 5G session management capability (5GSM Capability), and the like. Regarding the UE mobility management core network capability, it can be divided into S1 UE network capability (mainly used for core network parameters related to evolved universal terrestrial radio access network (E-UTRAN) access) and UE 5G mobility management core network capability (mainly including other UE capabilities related to interworking with 5G core network (CN) or evolved packet system (EPS)), and includes capabilities not related to radio, such as NAS security algorithms. The S1 UE network capability is transmitted between all core network (CN) nodes in changes from AMF to AMF, AMF to MME, MME to MME, and MME to AMF. The 5GMM core network capability of the UE is only transmitted in changes from AMF to AMF.

Referring to FIG. 2, an embodiment of this application provides a method for reporting sensing capability, including the following step:
Step 21: A first device reports sensing capability information of the first device;
where the sensing capability information is used to indicate at least one of the following:
capability of whether a sensing protocol is supported;
capability of whether receiving sensing service notification is supported;
capability of whether sensing through a first-device-to-first-device interface is supported;
capability of whether monostatic sensing is supported;
capability of whether sensing through a first-device-to-second-device interface is supported, the second device being of a different type from the first device;
capability of whether sending a sensing signal is supported;
capability of whether receiving or measuring a sensing signal is supported;
capability of whether providing sensing assistance information is supported;
sensing data processing capability;
capability of whether a target sensing mode is supported;
capability of whether sensing based on at least two target radio access technologies is supported;
capability of whether receiving a sensing request sent by a target device is supported;
capability of whether an application function selecting the first device to participate in sensing is supported;
capability of whether a target sensing scrambling algorithm is supported;
capability of whether a target sensing fuzzification algorithm is supported;
supported sensing resolution;
supported sensing accuracy; and
supported sensing service range.

In this embodiment of this application, the sensing capability of a device and the interaction procedure are defined, so that an appropriate device can be selected to participate in sensing in a sensing service.

In this embodiment of this application, optionally, the first device may be a base station or a UE or an auxiliary device capable of providing sensing information (for example, a watch, refrigerator, or camera that is not accessed via a non-3rd generation partnership project (3GPP)).

The above sensing capabilities are described in detail below.

### 1. Capability of Whether a Sensing Protocol is Supported

The sensing protocol is a protocol used to define procedures such as sensing configuration information interaction and sensing measurement reporting. The capability of whether a sensing protocol is supported also means whether sensing is supported.

For example, when the first device is a UE, the capability of whether a sensing protocol is supported means whether the UE supports the sensing protocol NR sensing protocol between the UE and a network function; and when the first device is a base station, the capability of whether a sensing protocol is supported means whether the base station supports the sensing protocol (that is, NR Sensing Protocol A) between the base station and a network function. The network function may be a sensing function (SF), or may be a core network function in the related art.

The sensing protocol may be a protocol that supports for sensing through extension based on a positioning protocol (for example, extending the LTE positioning protocol (LPP) and/or NR sensing protocol (NRSPA) to support sensing-related interactions between a UE and a network function and/or between a base station and a network function), or may be a newly defined protocol that supports sensing-related functions and procedure interactions.

In this embodiment of this application, optionally, the capability of whether a sensing protocol is supported includes at least one of the following:
(i) Capability of whether a sensing protocol in a 4G control plane interface mode is supported.

Optionally, when the first device is a UE, the capability of whether a sensing protocol is supported may be capability of whether a sensing protocol in a 4G (evolved UMTS terrestrial radio access (E-UTRA)) control plane interface mode is supported.

When the first device is a base station, the capability of whether a sensing protocol is supported may be capability of whether a sensing protocol in a 4G (E-UTRA) control plane interface S1 mode is supported.
(ii) Capability of whether a sensing protocol in a 5G control plane interface mode is supported.

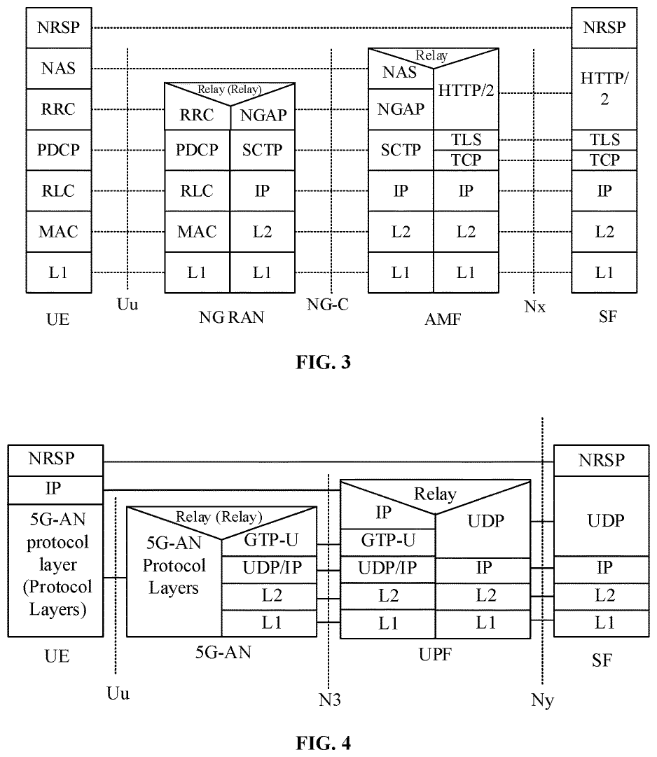

Optionally, when the first device is a UE, the capability of whether a sensing protocol is supported may be capability of whether a sensing protocol in a 5G control plane (N1) interface mode is supported, an example of which is shown in FIG. 3.

When the first device is a base station, the capability of whether a sensing protocol is supported may be capability of whether a sensing protocol in a 5G control plane (N2) interface mode is supported.
(iii) Capability of whether a sensing protocol in a 5G user plane interface mode is supported.

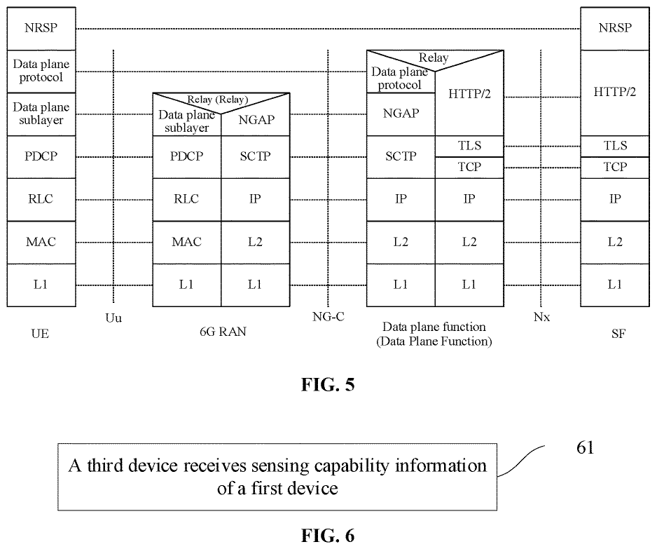

Optionally, when the first device is a UE, the capability of whether a sensing protocol is supported may be capability of whether a sensing protocol in a 5G user plane interface mode is supported, an example of which is shown in FIG. 4.

When the first device is a base station, the capability of whether a sensing protocol is supported may be capability of whether a sensing protocol in a 5G user plane (N3) interface mode is supported.
(iv) Capability of whether a sensing protocol in a 6G control plane interface mode is supported.
(v) Capability of whether a sensing protocol in a 6G user plane interface mode is supported.
(vi) Capability of whether a sensing protocol in a 6G data plane interface mode is supported.

The data plane is a plane added on the basis of the control plane CP and the user plane UP in the related art.

Optionally, when the first device is a UE, the capability of whether a sensing protocol is supported may be capability of whether a sensing protocol in a 6G data plane interface mode is supported, an example of which is shown in FIG. 5.
(vii) Capability of whether a sensing protocol in a 4G first-device-to-first-device interface mode is supported.

Optionally, when the first device is a UE, the capability of whether a sensing protocol is supported may be capability of whether a sensing protocol in a 4G UE-to-UE interface mode is supported.

Optionally, when the first device is a base station, the capability of whether a sensing protocol is supported may be capability of whether a sensing protocol in a 4G base station-to-base station (X2) interface mode is supported.
(viii) Capability of whether a sensing protocol in a 5G first-device-to-first-device interface mode is supported.

Optionally, when the first device is a UE, the capability of whether a sensing protocol is supported may be capability of whether a sensing protocol in a 5G UE-to-UE interface mode is supported.

Optionally, when the first device is a base station, the capability of whether a sensing protocol is supported may be the capability of whether a sensing protocol in a 5G base station-to-base station (Xn) interface mode is supported.
(ix) Capability of whether a sensing protocol in a 6G first-device-to-first-device interface mode is supported.

Optionally, when the first device is a UE, the capability of whether a sensing protocol is supported may be capability of whether a sensing protocol in a 6G UE-to-UE interface mode is supported.

When the first device is a base station, the capability of whether a sensing protocol is supported may be capability of whether a sensing protocol in a 6G base station-to-base station interface mode is supported.

In this embodiment of this application, “capability of whether a sensing protocol in a 4G first-device-to-first-device interface mode is supported”, or “capability of whether a sensing protocol in a 5G first-device-to-first-device interface mode is supported”, or “capability of whether a sensing protocol in a 5G first-device-to-first-device interface mode is supported”, mainly means the capability of interacting, sending, and receiving sensing-related information or data such as sensing configuration information or sensing data on the corresponding interface.

### 2. Capability of Whether Receiving Sensing Service Notification is Supported

In this embodiment of this application, optionally, the sensing service notification includes: whether privacy check is required for a sensing request.

In this embodiment of this application, optionally, the sensing service notification further includes: identity information of a sensing service client corresponding to the sensing request, or a service type corresponding to the sensing request.

Considering sensing security and privacy issues, usually the first device needs to perform a privacy check (privacy check) before performing sensing. A privacy check method based on sensing capability may be as follows: if an indicator of privacy check-related actions indicates that the first device (such as UE) must be notified or notified to perform a privacy check, and if the first device (such as UE) supports sensing service notification (based on the sensing capability information of the first device), a network function (such as AMF) sends a sensing service notification to the first device, indicating the identity of the sensing service client and/or the service type and whether a privacy check is required for the sensing request. The first device notifies the sensing request to a user of the first device (such as a mobile phone user, a base station owner), and if it requests that a privacy check is required for the sensing request, it waits for the user to grant or deny permission. Then, the first device returns a notification result to a network function (such as AMF), and if a privacy check is requested, it needs to indicate whether permission is granted or denied for the current sensing request. If the user of the first device does not respond after a predetermined period of time, the network function (such as AMF) should infer a “no response” condition (that is, the network function should give a potential reason for no response), and should return an error response to the sensing function (SF). If a privacy check is required, and the user of the first device denies permission or does not respond, the indication received by the network function (such as SF) indicates that the sensing request is prohibited. The notification result may also indicate a sensing privacy indication setting for subsequent sensing service requests; to be specific, whether subsequent sensing requests (if generated) will be allowed or disallowed by the first device. The sensing privacy indication may also indicate the time period during which subsequent sensing requests are disallowed.

### 3. Capability of Whether Sensing Through a First-Device-to-First-Device Interface is Supported

In this embodiment of this application, “capability of whether sensing through a first-device-to-first-device interface is supported” means a first device A sending a sensing signal, a first device B receiving the sensing signal, the first device A and the first device B being devices of the same type, for example, both being UEs or both being base stations, and “capability of whether sensing through a first-device-to-first-device interface is supported” mainly being a capability of sending and receiving a sensing signal on a radio interface.

When the first device is a UE, the first-device-to-first-device interface may be mapped to PC5 in the relevant protocols, that is, sensing performed based on sidelink (sidelink, which may also be referred to as side link); and when the first device is a base station, the first-device-to-first-device interface is an interface for sending and receiving wireless signals between base stations, rather than an interface for signal interaction between base stations based on wired connections.

In this embodiment of this application, optionally, the capability of whether sensing through a first-device-to-first-device interface is supported includes at least one of the following:
(i) Capability of whether sensing through a 4G first-device-to-first-device interface is supported.

Optionally, when the first device is a UE, the capability of whether sensing through a first-device-to-first-device interface is supported includes capability of whether sensing through a 4G UE-to-UE interface (E-UTRA-PC5) is supported.

Optionally, when the first device is a base station, the capability of whether sensing through a first-device-to-first-device interface is supported includes capability of whether sensing through a 4G base station-to-base station interface is supported. The first-device-to-first-device interface is an interface for sending and receiving wireless signals between base stations, rather than an interface (X2 interface) for signal interaction between base stations based on wired connections.
(ii) Capability of whether sensing through a 5G first-device-to-first-device interface is supported.

Optionally, when the first device is a UE, the capability of whether sensing through a first-device-to-first-device interface is supported includes capability of whether sensing through a 5G UE-to-UE interface (NR-PC5) is supported.

Optionally, when the first device is a base station, the capability of whether sensing through a first-device-to-first-device interface is supported includes capability of whether sensing through a 5G base station-to-base station interface is supported. The first-device-to-first-device interface is an interface for sending and receiving wireless signals between base stations, rather than an interface (Xn interface) for signal interaction between base stations based on wired connections.
(iii) Capability of whether sensing through a 6G first-device-to-first-device interface is supported.

Optionally, when the first device is a UE, the capability of whether sensing through a first-device-to-first-device interface is supported includes capability of whether sensing through a 6G UE-to-UE interface is supported.

Optionally, when the first device is a base station, the capability of whether sensing through a first-device-to-first-device interface is supported includes capability of whether sensing through a 6G base station-to-base station interface is supported. The first-device-to-first-device interface is an interface for sending and receiving wireless signals between base stations, rather than an interface for signal interaction between base stations based on wired connections.

### 4. Capability of Whether Monostatic Sensing is Supported

Self-sending and self-receiving may also be referred to as echolink sensing. Self-sending and self-receiving is a radar-like manner.

In this embodiment of this application, optionally, the capability of whether monostatic sensing is supported includes at least one of the following:
(i) Capability of whether monostatic sensing based on a 4G protocol is supported.

Optionally, when the first device is a UE, the capability of whether monostatic sensing is supported includes capability of whether monostatic sensing based on a 4G protocol (E-UTRA) is supported, for example, capability of monostatic sensing based on a 4G waveform through special time slots.

Optionally, when the first device is a base station, the capability of whether monostatic sensing is supported includes capability of whether monostatic sensing based on a 4G protocol is supported.
(ii) Capability of whether monostatic sensing based on a 5G protocol is supported.

Optionally, when the first device is a UE, the capability of whether monostatic sensing is supported includes capability of whether monostatic sensing based on a 5G protocol is supported.

Optionally, when the first device is a base station, the capability of whether monostatic sensing is supported includes capability of whether monostatic sensing based on a 5G protocol is supported.
(iii) Capability of whether monostatic sensing based on a 6G protocol is supported.

Optionally, when the first device is a UE, the capability of whether monostatic sensing is supported includes capability of whether monostatic sensing based on a 6G protocol is supported.

Optionally, when the first device is a base station, the capability of whether monostatic sensing is supported includes capability of whether monostatic sensing based on a 6G protocol is supported.

### 5. Capability of Whether Sensing Through a First-Device-to-Second-Device Interface is Supported

In this embodiment of this application, “capability of whether sensing through a first-device-to-second-device interface is supported” means the first device sending a sensing signal and the second device receiving the sensing signal, or the second device sending a sensing signal and the first device receiving the sensing signal. The first device and the second device are devices of different types. The second device is of a different type from the first device, for example, the first device is a UE, and the second device is a base station; or the first device is a base station, and the second device is a UE. “Capability of whether sensing through a first-device-to-second-device interface is supported” is mainly the capability of sending and receiving a sensing signal on a radio interface, which is different from the capability of whether a sensing protocol is supported in which sensing configuration information and sensing data are interacted based on sensing information on the control plane, user plane, or data plane of a network (such as a base station or AMF/SMF) and the control plane, user plane, or data plane of a UE.

In this embodiment of this application, optionally, the capability of whether sensing through a first-device-to-second-device interface is supported includes at least one of the following: capability of whether sensing through the first device sending a sensing signal and the second device receiving the sensing signal is supported; and capability of whether sensing through the first device receiving a sensing signal and the second device sending the sensing signal is supported.

### 6. Capability of Whether Sending a Sensing Signal is Supported

The sensing signal usually refers to a signal that can be used for sensing measurement, potentially a reference signal in the related art, such as a channel state information reference signal (CSI-RS) or a positioning reference signal (PRS), or may be a newly defined signal for sensing.

### 7. Capability of Whether Receiving or Measuring a Sensing Signal is Supported

Usually, after a sensing signal is received, it is also necessary to measure the received signal to generate a required sensing measurement quantity. The sensing measurement quantity includes, for example, delay, angle, Doppler, or signal strength.

A potential classification method is to classify the sensing measurement quantities into the following four categories (the following description focuses on describing the measurement quantities, which may also be classified into three categories or not classified, and the four categories are only for illustration). Based on the relationship between the sensing measurement quantities and the sensing service, the third-level and fourth-level measurement quantities below are usually also referred to as sensing results. The second-level and/or first-level measurement quantities are referred to as sensing measurement data.
(i) The first-level measurement quantity (received signal/original channel information) includes at least one of the following: complex results of received signals/channel responses, amplitude/phase, I channel/Q channel and their operation results (the operation includes addition, subtraction, multiplication, division, matrix addition, subtraction, multiplication, matrix transposition, trigonometric relationship operation, square root operation, and power operation, as well as threshold detection results and maximum/minimum value extraction results of the above operation results; the operation also includes fast Fourier transform (FFT)/inverse fast Fourier transform (IFFT), discrete Fourier transform (DFT)/inverse discrete Fourier transform (IDFT), two-dimensional FFT (2D-FFT), three-dimensional FFT (3D-FFT), matched filtering, autocorrelation operation, wavelet transform, and digital filtering, as well as threshold detection results and maximum/minimum value extraction results of the above operation results).
(ii) The second-level measurement quantity (basic measurement quantity) includes at least one of the following: delay, Doppler, angle, signal strength, and their multi-dimensional combination representation.
(iii) The third-level measurement quantity (basic attribute/state) includes at least one of the following: distance, speed, angle/position, radar cross-section (RCS), and acceleration.
(iv) The fourth-level measurement quantity (advanced attribute/state) includes at least one of the following: spatial position, whether a target exists, trajectory, action, expression, vital signs, quantity, imaging result, weather, air quality, shape, material, and composition.

### 8. Capability of Whether Providing Sensing Assistance Information is Supported

Usually, the sensing assistance information refers to information other than the measurement data obtained by measuring based on wireless signals defined by 3GPP, such as global positioning system (GPS) position information, time information, or picture information.

### 9. Sensing Data Processing Capability

Usually, sensing needs to process sensing measurement data to form a required result, or preprocess sensing measurement data (such as selection based on thresholds, or merging of multi-channel or multi-resource block (RB) data), and the complexity of sensing data processing is closely related to the algorithm. Some algorithms such as rain detection and breathing detection have lower complexity, while others like multiple signal classification (MUSIC) and artificial intelligence (AI)-based gesture recognition have higher complexity. Therefore, when sensing data processing capability is supported, levels can be further defined based on the complexity of sensing data processing or the computing/storage capability, for example, level 1 is 10e3 (that is, 10 to the third power, and so on) floating-point operations per second (FLOPS), level 2 is 10e6 FLOPS, and level 3 is 10e9 FLOPS.

To be specific, in this embodiment of this application, optionally, the sensing data processing capability includes at least one of the following: capability of whether sensing data processing, level information of sensing data processing complexity, level information of sensing data computing capability, and level information of sensing data storage capability are supported.

In this embodiment of this application, optionally, sensing data includes at least one of the following:
(i). sensing measurement result, including at least one of the following:
I/Q data of received sensing signals;
delay, angle, Doppler, intensity, or multi-bit combination data of the four; and
sensing results such as speed, position, or intrusion status;
(ii) sensing measurement result validity indication; and
(iii) sensing assistance data, where the sensing assistance data is used to assist in calculating a sensing result, the sensing assistance data including, for example, GPS position or time information.

### 10. Capability of Whether a Target Sensing Mode is Supported

The capability of whether a target sensing mode is supported is used to indicate whether the first device supports the capability of one or more target sensing modes.

In this embodiment of this application, optionally, the target sensing mode includes at least one of the following:
(i) a base station sending a sensing signal and a terminal receiving the sensing signal, the first device being the base station or the terminal;
(ii) a base station performing self-sending and self-receiving of a sensing signal, where the first device is the base station; and in this mode, the base stations sending and receiving the sensing signal are the same base station;
(iii) a first base station sending a sensing signal and a second base station receiving the sensing signal, where the first device is one of the first base station and the second base station; and in this mode, the base stations sending and receiving the sensing signal are different base stations;
(iv) a terminal sending a sensing signal and a base station receiving the sensing signal, the first device being the base station or the terminal;
(v) a terminal performing self-sending and self-receiving of a sensing signal, where the first device is the terminal; and in this mode, the UEs sending and receiving the sensing signal are the same UE; and
(vi) a first terminal sending a sensing signal and a second terminal receiving the sensing signal, where the first device is one of the first terminal and the second terminal; and in this mode, the UEs sending and receiving the sensing signal are different UEs.

### 11. Capability of Whether Sensing Based on at Least Two Target Radio Access Technologies (RAT) is Supported

The capability of whether sensing based on at least two target radio access technologies is supported is used to identify whether the first device supports sensing based on more than one target radio access technology.

The target radio access technology may include 3GPP technology access such as 4G, 5G, or 6G, and may also include non-3GPP access technologies such as Wi-Fi and Bluetooth.

The capability of whether sensing based on at least two target radio access technologies is supported may be, for example, capability of whether sensing based on 4G (E-UTRA) and 5G (NR) is supported; capability of whether sensing based on 5G and 6G is supported, and capability of whether sensing based on 4G and 6G is supported.

The number of radio access technologies may be greater than or equal to 2, and herein two RATs (first access technology and second access technology) are taken as an example for description.

In this embodiment of this application, optionally, the capability of whether sensing based on at least two target radio access technologies is supported includes at least one of the following:
(i) Capability of whether the following is supported: the first device sending sensing data to a second device based on a first access technology, the sensing data including: sensing data obtained by the first device based on a second access technology.

For example, capability of whether the following is supported: a UE sending sensing data to a base station based on 5G, the sensing data including: sensing data obtained by the UE based on 6G.
(ii) Capability of whether the following is supported: the first device receiving sensing configuration information from a second device based on a first access technology, the sensing configuration information being used to configure sensing of the first device based on a second access technology.

For example, capability of whether the following is supported: a UE receiving sensing configuration information from a base station based on 5G, the sensing configuration information being used to configure sensing of the UE based on 6G.

Optionally, the sensing configuration information includes at least one of the following:
(a) sensing measurement object configuration information; where the sensing measurement object configuration information is used to configure a sensing measurement object; and in some optional embodiments, the above sensing measurement object configuration information may include at least one of the following: waveform type, subcarrier spacing, guard interval, bandwidth, burst duration, time domain interval, transmission power of a sensing signal, transmission port information of a sensing signal, signal format, signal direction, beam information of a sensing signal, time resource, frequency resource, and quasi-co-location (QCL) relationship;
(b) sensing measurement item configuration information; where the sensing measurement item configuration information is used to configure a sensing measurement quantity;
(c) sensing measurement report configuration information; and
(d) sensing data transmission configuration information.
(iii) Capability of whether the following is supported: the first device sending a sensing signal based on a first access technology and receiving a sensing signal based on a second access technology.

In this embodiment of this application, optionally, it may be that the first device has the capability within an agreed time (for example, 10 ms), for example, capability of whether the following is supported: within 10 ms, a UE sending a sensing signal based on 5G and receiving a sensing signal based on 6G.
(iv) Capability of whether the following is supported: the first device sending a sensing signal based on a first access technology and sending a sensing signal based on a second access technology.

In this embodiment of this application, optionally, it may be that the first device has the capability within an agreed time (for example, 10 ms), for example, capability of whether the following is supported: within 10 ms, a UE sending a sensing signal based on 5G and sending a sensing signal based on 6G.
(v) Capability of whether the following is supported: the first device receiving a sensing signal based on a first access technology and receiving a sensing signal based on a second access technology.

In this embodiment of this application, optionally, it may be that the first device has the capability within an agreed time (for example, 10 ms), for example, capability of whether the following is supported: within 10 ms, a UE receiving a sensing signal based on 5G and sending a sensing signal based on 6G.

### 12. Capability of Whether Receiving a Sensing Request Sent by a Target Device is Supported

In this embodiment of this application, optionally, the target device includes at least one of the following:
an application function (AF);
a network function, the network function including a radio access network function (such as a base station) or a core network function (such as AMF); and
a terminal.

### 13. Capability of Whether an Application Function Selecting the First Device to Participate in Sensing is Supported

Based on security considerations, usually the device selecting a node participating in sensing is a core network function and/or a radio access network function. In this embodiment of this application, it may also support an application function selecting the first device to participate, for example, the application function indicates the first device to participate in sensing in a sensing request. However, since the application function selecting the first device to participate in sensing may have potential risks such as the first device being captured or denial of service, it is necessary for the first device to comprehensively consider multiple factors to indicate in the capability whether the application selecting the first device to participate in sensing is supported.

Participating in sensing includes at least one of the following: sending a sensing signal; receiving a sensing signal; providing sensing assistance information; and processing sensing measurement data (for example, processing sensing measurement data such as delay and angle to generate position information).

### 14. Capability of Whether a Target Sensing Scrambling Algorithm is Supported

The capability of whether a target sensing scrambling algorithm is supported can be analogous to communication security capability, and sensing involves information of users or physical environments and also needs to consider sensing security issues. This target sensing scrambling algorithm refers to a signal scrambling scheme similar to that in a communication system. The first device needs to generate a scrambling sequence based on a scrambling initial value associated with a sensing service or measure a scrambled sensing signal to realize interference randomization of the scrambled signal, so that interference between signals oriented to communication and sensing, different sensing services, different sensing areas, different sensing targets is randomized, which can be applicable to various sensing application scenarios and improve sensing performance.

In this embodiment of this application, optionally, the first device is a transmitter of a sensing signal, scrambling is used for sensing signal generation, and the capability of whether a target sensing scrambling algorithm is supported includes: scrambling the sensing signal using a scrambling sequence.

In this embodiment of this application, optionally, the first device is a receiver of a sensing signal, scrambling is used for sensing measurement, and the capability of whether a target sensing scrambling algorithm is supported includes: determining a scrambling sequence, and descrambling a received sensing signal based on the scrambling sequence.

If an unscrambled sensing signal (first signal) is a signal carrying communication data (that is, the unscrambled sensing signal (first signal) is unknown to the first device), the first device descrambles a received sensing signal (third signal) using a scrambling sequence, and further decodes the signal to obtain data information of a transmitter; and/or determines a scrambled sensing signal (second signal), and obtaining a sensing measurement result based on the received sensing signal (third signal) and the scrambled sensing signal (second signal).

If an unscrambled sensing signal (first signal) is a reference signal or a synchronization signal or a dedicated sensing signal (that is, the first signal is known to the first device), the first device determines a scrambled sensing signal (second signal) based on the unscrambled sensing signal (first signal) and a scrambling sequence, and obtains a sensing measurement result based on a received sensing signal (third signal) and the scrambled sensing signal (second signal).

The transmitter scrambles a first signal using a scrambling sequence to obtain a second signal. The third signal is a signal received by the receiver after the second signal is sent through a channel.

In this embodiment of this application, optionally, the scrambling sequence is determined based on first information, the first information including at least one of the following: sensing area identifier;
identifier of whether used for sensing;
sensing service identifier;
sensing service type identifier;
sensing target identifier;
tag identifier associated with a sensing target;
device identifier participating in sensing measurement; for example, it may be a cell identifier or a terminal identifier (for example, radio network temporary identity (RNTI));
time domain resource or frequency domain resource information used for sensing; for example, index of time domain resource unit (radio frame number, subframe number, slot number, symbol number), and index of frequency domain resource unit; and
codeword number; where
the role of the codeword number in sensing is to perform code division multiplexing, achieving the effect of supporting multiple users on the same resource.

In this embodiment of this application, optionally, the scrambling sequence includes at least one of the following:
pseudo-random PN sequence, an initial value of the PN sequence being associated with the first information;
ZC (Zadoff-Chu) sequence, a root sequence number or cyclic shift value of the ZC sequence being associated with the first information; and
linear frequency modulation chirp (Chirp) signal or frequency modulation continuous wave (FMCW) signal, a frequency modulation slope or starting frequency of the Chirp signal or FMCW signal being associated with the first information.

### 15. Capability of Whether a Target Sensing Fuzzification Algorithm is Supported

The capability of whether a target sensing fuzzification algorithm is supported can be analogous to communication security capability, fuzzifying the sensing measurement data obtained by measurement, thereby reducing the accuracy of the sensing data provided by the first device and avoiding exposing data with too high accuracy.

In this embodiment of this application, optionally, the capability of whether a target sensing fuzzification algorithm is supported includes at least one of the following:
adding random noise to sensing measurement data;
adding random noise to sensing measurement data before coordinate transformation of the sensing measurement data, the coordinate transformation including at least one of the following: transforming from polar coordinate system to rectangular coordinate system, and transforming from rectangular coordinate system to polar coordinate system;
adding random noise to Kalman filtered sensing measurement data; and
after performing state prediction on sensing measurement data, adding random noise to a state prediction result.

### 16. Supported Sensing Resolution

The sensing resolution can be used to distinguish different targets or events or attributes.

In this embodiment of this application, optionally, the sensing resolution includes at least one of the following:
distance resolution;
delay resolution;
angle resolution;
speed resolution; and
Doppler resolution.
   17. Supported Sensing Accuracy (which May Also be Referred to as Sensing Error)

It is used to indicate the error law between the data value of the sensing measurement quantity obtained by measurement of the first device and its corresponding true value. It can be expressed as an absolute value or standard deviation.

In this embodiment of this application, optionally, the sensing accuracy includes at least one of the following:
distance error;
delay error;
angle error;
speed error;
Doppler error;
detection probability;
false alarm probability; and
recognition accuracy rate.

### 18. Supported Sensing Service Range

Considering factors such as the sending function and receiving sensitivity of the first device, this item is used to support the range of sensing services, for example, a spherical range with a radius of R at the location of the first device.

The sensing capabilities described in 12 to 17 above may also be referred to as sensing security capabilities.

In this embodiment of this application, optionally, the first device is a terminal, and the first device reports the sensing capability information of the first device through a registration request message.

In this embodiment of this application, optionally, the first device is a terminal, and the sensing capability information is contained in a terminal mobility management core network capability.

In this embodiment of this application, optionally, the first device is a base station, and the first device reports the sensing capability information of the first device through an N2 message.

In this embodiment of this application, optionally, the first device is a base station, and the first device reports the sensing capability information of the first device through a cell list, the cell list including at least one cell of the first device and the sensing capability information corresponding to each cell.

In this embodiment of this application, optionally, that a first device reports sensing capability information of the first device includes:
the first device receives sensing capability query information, the sensing capability query information including: an identifier of the first device or a cell identifier of the first device, and information of a sensing capability that needs to be queried; and
the first device reports the sensing capability information that needs to be queried based on the sensing capability query information.

In this embodiment of this application, optionally, before the first device receives sensing capability query information, the method further includes:
the first device actively reports capability of supporting a sensing protocol.

In this embodiment of this application, optionally, the sensing capability query information is sent through a data collection request on a data plane.

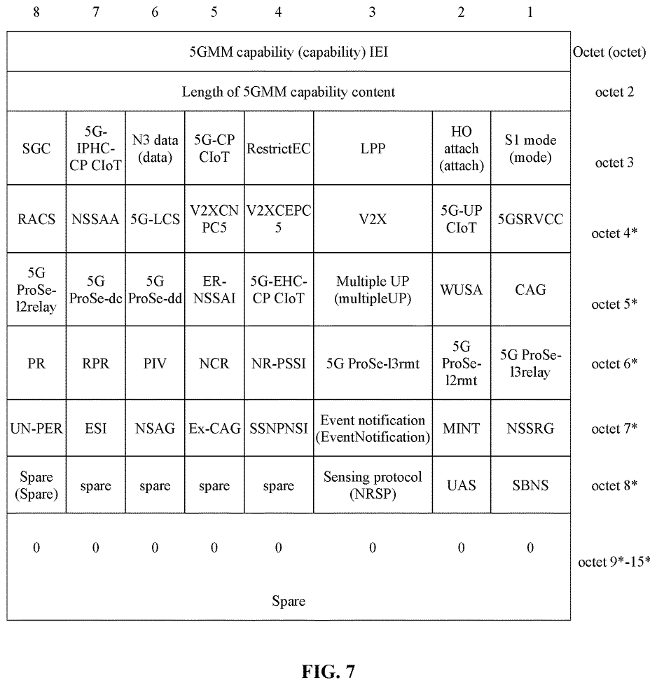

Referring to FIG. 6, an embodiment of this application further provides a method for receiving sensing capability, including the following step:
Step 61: A third device receives sensing capability information of a first device;
where the sensing capability information is used to indicate at least one of the following: capability of whether a sensing protocol is supported;
capability of whether receiving sensing service notification is supported;
capability of whether sensing through a first-device-to-first-device interface is supported;
capability of whether monostatic sensing is supported;
capability of whether sensing through a first-device-to-second-device interface is supported, the second device being of a different type from the first device;
capability of whether sending a sensing signal is supported;
capability of whether receiving or measuring a sensing signal is supported;
capability of whether providing sensing assistance information is supported;
sensing data processing capability;
capability of whether a target sensing mode is supported;
capability of whether sensing based on at least two target radio access technologies is supported;
capability of whether receiving a sensing request sent by a target device is supported;
capability of whether an application function selecting the first device to participate in sensing is supported;
capability of whether a target sensing scrambling algorithm is supported;
capability of whether a target sensing fuzzification algorithm is supported;
supported sensing resolution;
supported sensing accuracy; and
supported sensing service range.

For the detailed description of the above sensing capabilities, refer to the description in the embodiments of the method for reporting sensing capability, which will not be repeated.

Optionally, after the third device receives sensing capability information of a first device, the method further includes:
the third device selects, based on the sensing capability information of the first device, a target first device to participate in sensing.

Optionally, the third device is a core network device, such as AMF.

The sensing function (SF) involved in the above embodiments is described below.

The sensing function node includes at least one of the following functions:
receiving a sensing service request, and determining a required sensing measurement quantity based on the sensing service request;
receiving a sensing measurement result (that is, a value of a sensing measurement quantity), where the sensing measurement quantity is a first level measurement quantity and/or a second level measurement quantity, generating a sensing result (third level measurement quantity), and responding to the sensing service request; and in this embodiment of this application, this function is referred to as a basic sensing function node;
receiving a sensing measurement result of the third level measurement quantity, generating a sensing result (fourth level measurement quantity), and responding to the sensing service request; and in this embodiment of this application, this function is referred to as a derivative sensing function node;
receiving a sensing measurement result (that is, a value of a sensing measurement quantity), where the sensing measurement quantity is a first level measurement quantity and/or a second level measurement quantity and/or a third level measurement quantity, generating a sensing result (fourth level measurement quantity), and responding to the sensing service request; and in this embodiment of this application, this function is referred to as a comprehensive sensing function node;
sensing quality of service (QoS) control, that is, controlling sensing-related nodes oriented to sensing service quality requirements, thereby meeting the sensing service QoS requirements;
determining a sensing signal sending or receiving node or a sensing assistance node, where a sensing signal sending or receiving node in a mobile communication system includes a network device (such as a base station) and a UE (such as a mobile phone), and the sensing assistance node refers to a node used to provide sensing assistance information such as sensing information and geographic location information of other sensors to improve the performance of wireless sensing;
determining a sensing link or a sensing method, where the sensing link may include a Uu link (base station sending/UE receiving or base station receiving/UE sending), a sidelink (sending and receiving between UEs), and an echo link (base station bistatic, UE bistatic), sending and receiving link between base stations (sending and receiving between base stations); and the sensing method may include base station sending and UE receiving, UE sending and base station receiving, base station sending and receiving, sending and receiving between UEs, sending and receiving between base stations, and UE sending and receiving;
determining a sensing signal, where a potential sensing signal includes a reference signal or a data signal, and the reference signal may be a communication reference signal or a sensing dedicated reference signal;
determining time-frequency resources used for sensing, where potential sensing resources include time-frequency resources not used in communications (such as guard bands), time-frequency resources already used in shared communications (such as reference signals or data signals), and time-frequency resources dedicated to sensing; furthermore, determining a configuration of the sensing signal, where a potential configuration includes time-, frequency-, and spatial-domain resource information of the sensing signal; and if the node determining the sensing time-frequency resources is not the sending node of the sensing signal, sending a sensing signal configuration to the sensing signal sending node;
determining a configuration of a sensing measurement quantity, where a potential configuration includes an indication of a sensing signal to be measured, the number or time of sensing signals to be measured, a reporting indication of a measurement result, and if the node determining the configuration of the sensing measurement quantity is not the receiving and measuring node of the sensing signal, sending the configuration of the sensing measurement quantity to the sensing signal receiving node;
determining and configuring a transmission channel for reporting a sensing measurement result, which include establishing, modifying or releasing the transmission channel; and
determining an AMF, after the network side determines a sensing function node based on a geographic range of a requested sensing service and a geographic range of a sensing service provided by the sensing function node, the sensing function node needs to determine the AMF in at least one of the following cases: (i) when a UE is a sensing signal sending node, or a sensing signal receiving node, or a sensing assistance node, and a sensing target is a certain UE, the sensing function node selects the AMF based on a geographic area required for sensing, and based on a tracking area identity (TAI) of the AMF requested from NRF, and/or AMF ID/location; (ii) when sensing data needs to be sent via the AMF (for example, defined as a NAS message or the NAS layer as a transmission bearer protocol layer for sensing data), the sensing function node selects the AMF based on geographic position information of a sensing node requiring transmission of data (such as a tracking area (TA)), and based on a TAI of the AMF requested from NRF, and/or AMF ID/location; and (iii) when the sensing target is a 3GPP UE, the sensing function node determines the AMF based on a UE identifier (such as AMF UE NGAP ID).

The above method of this embodiment of this application is illustrated below in conjunction with specific application scenarios.

### Embodiment 1

This embodiment is an interaction procedure of sensing capability enhanced based on 5G protocol when the first device is a UE.

As defined in 23.502 4.2.2.2.2, the UE provides UE capability information in a registration procedure (Registration procedure), where the capability information is processed by the AMF. Therefore, when the first device is a UE, a potential interaction procedure of sensing capability includes the following steps:
Step 1: A UE sends a registration request message, where the registration request message includes at least one of the following:
(a) UE radio capability update (UE Radio Capability Update) including sensing capability;
where in a communication and sensing integration scenario, the radio sensing capability information of a device is a collection of information that characterizes whether the device can perform a specific sensing service and the performance level that can be achieved around the specific sensing service, and includes a first ability set and a second ability set;
the first ability set is a sensing-enhanced ability set (Sensing-Enhanced Ability Set); and the second ability set is a sensing-specific ability set (Sensing-Specific Ability Set).

### (1) First Ability Set

The first ability set includes the following contents:
(i). Frequency-related capabilities, including:
band (band)/band combination (band combination) supporting sensing function and corresponding bandwidth;
capability of sending and receiving a sensing signal supported by each band/band combination, including: supporting sending a sensing signal, supporting receiving a sensing signal, supporting time-division sending and receiving a sensing signal, and supporting simultaneously sending and receiving a sensing signal; and
number of independent radio frequency channels or number of antennas or antenna layout for sending/receiving a sensing signal supported by each band/band combination.
(ii). Power-related capabilities, including:
supported sensing signal power level, sensing signal maximum peak power, and sensing signal maximum average power;
supported maximum transmission time proportion of a sensing signal, maximum transmission power of a given transmission time proportion of a sensing signal;
whether power adaptive adjustment of a sensing signal is supported, with power control step size such as 1 dB, and range of power control such as −50 dBm to 23 dBm; and
whether maximum power backoff mechanism is supported, and if supported, supported maximum power backoff value.
(iii). Beam-related capabilities, including:
whether sensing signal sending beam scanning or receiving beam scanning is supported;
whether sensing signal sending beam selection or receiving beam selection is supported;
whether sensing signal sending beam adaptation or receiving beam adaptation is supported;
whether sensing signal sending beam shaping or receiving beam shaping is supported; and
whether sensing signal beam measurement and beam reporting is supported.

### (2) Second Ability Set

The second ability set includes the following contents:
(i). Sensing-specific radio frequency capabilities, including:
whether bandwidth splicing of a sensing signal and corresponding signal processing is supported; where the bandwidth splicing refers to generating, sending, receiving, and processing a sensing signal using discontinuous bands to achieve specific sensing performance requirements.
whether simultaneous multi-beam sending is supported, where the multi-beams include: communication beam, sensing beam, and communication sensing beam;
switching speed of a sensing beam, with capability levels classified by beam switching time; and
whether sensing signal frequency hopping is supported; if sensing signal frequency hopping is supported, further including whether frequency hopping between sensing signal periods or frequency hopping between sensing signal frames is supported; where
the sensing signal period refers to the time for one sensing signal sending and receiving, which is the basic unit of time dimension resource scheduling of a sensing signal; and
the sensing signal frame includes several sensing signal periods, and the specific number of sensing signal periods included is set based on sensing requirements.
(ii). Supported sensing service types, including:
whether radar detection service is supported, if supported, further including: radar speed measurement, radar ranging, radar angle measurement, and radar imaging;
whether user positioning and tracking service is supported;
whether three-dimensional reconstruction service is supported, if supported, further including: terrain reconstruction and building surface reconstruction;
whether weather and/or air quality detection service is supported, if supported, further including: rainfall detection, humidity detection, particulate matter (PM2.5/PM10) detection, and snowfall detection;
whether pedestrian flow/vehicle flow detection service is supported;
whether health monitoring service is supported, if supported, further including: heartbeat monitoring and breathing detection;
whether action recognition service is supported, if supported, further including: gesture recognition, posture recognition, and intrusion detection; and
whether radio frequency identification (RFID) or backscatter (backscatter)-based sensing signal sending or receiving is supported.
(iii) Supported sensing signal waveforms, including:
communication signals, including: new radio (NR) signals, Wi-Fi signals; if NR signals are supported as sensing signals, further including: supporting communication data signals as sensing signals, supporting reference signals/synchronization signals ((SSB)/channel state information reference signal (CSI-RS)/demodulation reference signal (DMRS)/phase-tracking reference signal (PTRS)/sounding reference signal (SRS)/positioning reference signals (PRS)) as sensing signals; and if Wi-Fi signals are supported as sensing signals, further including: supporting communication data signals as sensing signals, supporting reference signals/synchronization signals (preamble/CSI-RS) as sensing signals;
sensing signals, including: frequency modulation continuous wave (FMCW) radar signals, orthogonal frequency division multiplexing (OFDM) radar signals (including phase-coded OFDM radar signals), linear frequency modulation (LFM) signals, simple pulse train signals, phase-coded radar signals, or other signal waveforms designed specifically for sensing; and
communication and sensing integrated signals, including: reference signals designed for sensing functions, including: periodic reference signals, aperiodic reference signals, and full-bandwidth reference signals; further, supporting the above sensing signal waveforms is divided into: supporting sending the above sensing signal waveforms, supporting receiving the above sensing signal waveforms, supporting time-division sending and receiving the above sensing signal waveforms, and supporting simultaneously sending and receiving the above sensing signal waveforms.
(iv) Supported sensing measurement quantities, including:
original channel information: channel matrix H or compressed quantized information of H, channel state information (CSI), for example, amplitude/square of amplitude and/or phase of frequency domain channel response, or I-channel and Q-channel signal characteristics of frequency domain channel response, for example, amplitude/square of amplitude of I-channel and/or Q-channel signal;
signal strength information: reference signal received power (RSRP), and received signal strength indication (RSSI);
spectral information: channel power delay profile (PDP), Doppler power spectrum, power azimuth spectrum (PAS), pseudo-spectrum information (such as MUSIC spectrum), delay-Doppler two-dimensional spectrum, and delay-Doppler-angle three-dimensional spectrum;
multi-path information: power, phase, delay, angle information of each path (at least including first arrival path, line of sight (LOS) path, first-order reflection path, multi-order reflection path) in a multi-path channel;
angle information: angle of arrival, and angle of departure (including angle information on a UE side, angle information on a base station side, and angle information at a reflection point);
difference information of signals corresponding to different antennas: quotient or conjugate multiplication of frequency-domain channel response of a first antenna and a second antenna (or amplitude or phase of quotient or conjugate multiplication of frequency-domain channel response of a first antenna and a second antenna, or I channel or Q channel of quotient or conjugate multiplication of frequency-domain channel response of a first antenna and a second antenna, or projection operation of I channel or Q channel of quotient or conjugate multiplication of frequency-domain channel response of a first antenna and a second antenna, and the projection operation may be I*cos(theta)+Q*sin(theta), where theta is a certain angle value, different theta correspond to different projections, I represents I path data, and Q represents Q path data), amplitude ratio or amplitude difference of received signals of a first antenna and a second antenna, phase difference of signals of a first antenna and a second antenna, and delay difference of signals of a first antenna and a second antenna;
target parameter information determined based on original channel information: Doppler spread, Doppler shift, maximum delay spread, angle spread, coherent bandwidth, and coherent time; and
in addition to the above measurement quantities, also including new measurement quantities generated by operations based on two or more of the above measurement quantities.
(v) Supported sensing indicators, including:
sensing coverage range: the spatial range that can be covered by a device performing a specific sensing service under certain requirements, for example, distance range of radar detection, and area range of weather detection;
sensing resolution: when a device performing a specific sensing service can distinguish two different targets or events or attributes in a specific dimension, the difference between the two targets or events or attributes, for example, ranging resolution, angle measurement resolution, and speed measurement resolution;
sensing accuracy (or sensing error): the error law between a target or event or attribute obtained by a device performing a specific sensing service and its corresponding true value, which can be expressed as an absolute value or standard deviation, for example, ranging error, and rainfall rate measurement error in weather detection;
sensing delay-related capability: including: delay between the moment of receiving a sensing requirement and the moment of sending a sensing signal, delay between the moment of receiving a sensing requirement and receiving a sensing signal, delay between the moment of receiving a sensing signal and the completion of generating a sensing measurement quantity, and delay between the moment of receiving a sensing signal and the moment of reporting a sensing measurement quantity; where the sensing delay is quantized into several symbol periods or other time units, and the sensing signal delay supported by the device is described based on a sensing measurement quantity or a set of sensing measurement quantities, to be specific, the UE can report different sensing delays corresponding to each measurement quantity or each set of measurement quantities; the moment of receiving a sensing signal includes the start moment or end moment of receiving a sensing signal; and the moment of sending a sensing signal includes the start moment or end moment of sending a sensing signal;
detection probability: the probability that a device performs a sensing service and correctly detects the existence of a target or the occurrence of an event when a specific target exists or an event occurs; for example, the probability that personnel intrusion can be correctly detected in intrusion detection; and
false alarm probability: the probability that a device performs a sensing service and erroneously reports the existence of a target or the occurrence of an event when a specific target does not exist or an event does not occur; for example, the probability that the device reports personnel intrusion when there is no personnel intrusion in intrusion detection.
(vi). Supported sensing-related control/scheduling capabilities, including:
whether simultaneously scheduling control information for communications and sensing is supported, including: simultaneously scheduling only communications, simultaneously scheduling only sensing, simultaneously scheduling communications and sensing, and simultaneously scheduling communication and sensing integration; where scheduling sensing includes the device receiving control information, where the control information schedules the device to detect a downlink sensing signal or schedules the device to send an uplink sensing signal; and scheduling communications includes the device receiving control information, where the control information schedules the device to receive downlink data or send uplink data;
number of services simultaneously supported in one time unit, including: number of simultaneously supported services and number of time-division supported services; further divided into: number of simultaneously supported sensing services, number of simultaneously supported sensing signal waveforms, number of simultaneously detected sensing signals, and number of simultaneously supported/processed sensing measurement quantities;
whether indicating and/or reporting a sensing service type, and/or a sensing signal waveform, and/or a sensing measurement quantity with physical layer signaling is supported; and
physical layer cache size for temporary storage of sensing data.
(vii) Capabilities of sensing-related assistance information, including the following contents:
mobility of the device itself: refers to the motion characteristics that the device may have, a specific sensing service has certain requirements for the motion characteristics of the device performing the service, for example, positioning service usually requires the device to be stationary or low-speed motion, while synthetic aperture radar imaging service requires the device to have a certain motion speed; the mobility of the device can be classified as follows:
stationary device: for example, base station, transmission reception point (TRP), and Wi-Fi router;
low-speed device: for example, smart home device;
medium-speed device: for example, mobile phone (moving with pedestrians); and high-speed device: for example, vehicle radar; and
capability and accuracy of acquiring position/posture/motion information of the device itself: many use cases in communication and sensing integration need to use position/posture/motion information of the device, the capability and accuracy of acquiring position/posture/motion information of the device determine the type of sensing service that it can perform, for example, positioning service requires the device to have higher accuracy position information, while weather sensing service has lower requirements for device position information (for example, position error can be on the order of tens of meters).
(b) UE mobility management core network capability (UE MM Core Network Capability) including sensing capability information, where the sensing capability information is used to indicate at least one of the foregoing 1 to 18, which will not be repeated herein.

The following only takes several parameters as examples to give potential definition examples of UE mobility management core network capability including sensing capability information, and does not list all potential combinations of all the above 1 to 18 parameters of this application, and the English names defined in the standards are only examples, and may be other names. An example of a potential definition of UE mobility management core network capability including sensing capability is shown in FIG. 7. The NRSP field indicates whether the UE supports a sensing protocol, where the sensing protocol may be an LPP that extends support for sensing based on a positioning protocol, or may be a newly defined sensing protocol in an N1 (5G control plane interface) mode, or may be a newly defined sensing protocol based on a 5G user plane interface.

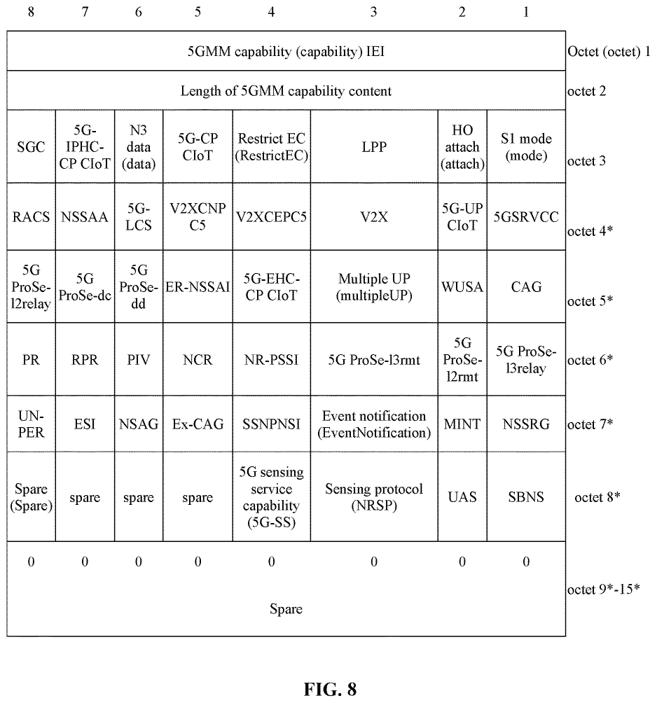

An example of a potential definition of UE mobility management core network capability including sensing capability is shown in FIG. 8. The sensing protocol is as described in FIG. 7 above. The capability of whether 5G sensing service notification is supported, if the first device supports sensing service notification, indicates that the first device can receive a sensing service notification, which is used to indicate information such as the identity of a sensing service client and/or service type and whether a privacy check is required. Considering sensing security and privacy issues, usually the first device needs to perform a privacy check before performing sensing. A privacy check method based on sensing capability may be as follows: if an indicator of privacy check-related actions indicates that the first device (such as UE) must be notified or notified to perform a privacy check, and if the first device (such as UE) supports sensing service notification (based on the sensing capability information of the first device), a network function (such as AMF) sends a sensing service notification to the first device, indicating the identity of the sensing service client and/or the service type and whether privacy check is required for the sensing request. The first device notifies the sensing request to a user of the first device (such as a mobile phone user, a base station owner), and if it requests that a privacy check is required for the sensing request, it waits for the user to grant or deny permission. Then, the first device returns a notification result to a network function (such as AMF), and if a privacy check is requested, it needs to indicate whether permission is granted or denied for the current sensing request. If the user of the first device does not respond after a predetermined period of time, the network function (such as AMF) should infer a “no response” condition (that is, the network function should give a potential reason for no response), and should return an error response to the sensing function (SF). If a privacy check is required, and the user of the first device denies permission or does not respond, the indication received by the network function (such as SF) indicates that the sensing request is prohibited. The notification result may also indicate a sensing privacy indication setting for subsequent sensing service requests; to be specific, whether subsequent sensing requests (if generated) will be allowed or disallowed by the first device. The sensing privacy indication may also indicate the time period during which subsequent sensing requests are disallowed.

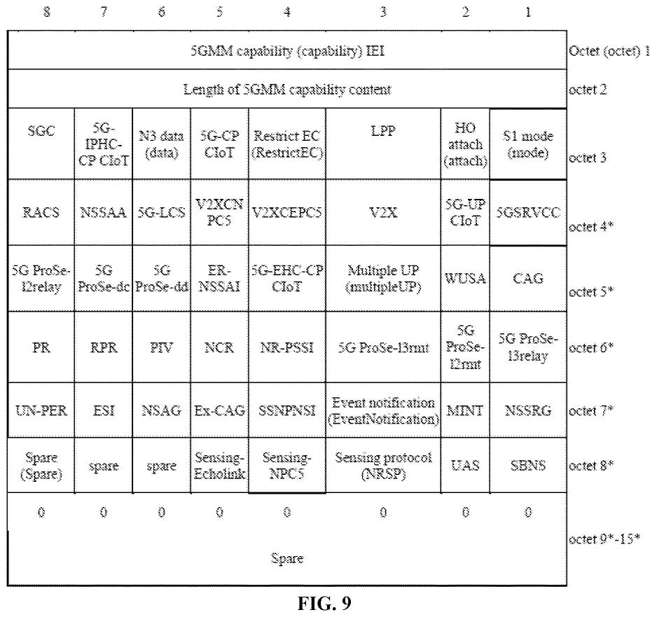

An example of a potential definition of UE mobility management core network capability including sensing capability is shown in FIG. 9. The NRSP field indicates the capability of whether the UE supports a sensing protocol. Sensing-NPC5 indicates whether the UE supports sensing through an NR-PC5 (UE-to-UE interface) interface. Sensing-Echolink indicates whether the UE supports sensing through self-sending and self-receiving.

For the subsequent steps of the registration procedure, refer to the definitions in 23.502, which will not be described one by one herein. If the AMF receives UE radio capability including sensing capability information, the AMF stores the UE radio capability and sends it to a radio access network node to avoid frequent reporting of UE radio capability over the air interface. Through the registration procedure, the AMF receives and stores UE mobility management (MNM) core network capability (MM Core Network Capability) including sensing capability information.
Step 2: An AF sends a sensing requirement to a NEF;
Step 3: After receiving the sensing requirement of the AF, the NEF selects an appropriate SF, if UE participation in sensing is required, then the SF selects an appropriate AMF, and sends a UE selection request to the AMF. The UE selection request includes at least one or more of the following information:
(a) sensing target area: refers to an area where a sensing object may exist, or a position area that needs imaging or three-dimensional reconstruction;
(b) sensing object type: classifying sensing objects based on possible motion characteristics of sensing objects, each sensing object type including typical motion speed, motion acceleration, and typical RCS of sensing objects;
(c) sensing target object: during performing sensing on one or more sensing target objects, providing identification information of the sensing objects, where potential identification methods include: feature identification on distance, speed, angle spectrum, or network identifiable UE ID; and
(d) sensing QoS: performance indicators for sensing a sensing target area or sensing object, including at least one of the following: sensing resolution (further may be divided into: ranging resolution, angle measurement resolution, speed measurement resolution, and imaging resolution), sensing accuracy (further may be divided into: ranging accuracy, angle measurement accuracy, speed measurement accuracy, and positioning accuracy), sensing range (further may be divided into: ranging range, speed measurement range, angle measurement range, and imaging range), sensing delay (time interval from sending a sensing signal to obtaining a sensing result, or time interval from initiating a sensing requirement to obtaining a sensing result), sensing update rate (time interval between two adjacent executions of sensing and obtaining sensing results), detection probability (probability of being correctly detected when a sensing object exists), and false alarm probability (probability of erroneously detecting a sensing target when a sensing object does not exist).
Step 4: The AFM selects, based on UE capability information and UE state information, an appropriate UE to participate in sensing, and sends a UE selection response to the SF, where the UE selection response includes at least an identifier of at least one UE, or optionally identifiers of multiple UEs.

### Embodiment 2

This embodiment is an interaction procedure of sensing capability enhanced based on 5G protocol when the first device is a base station.

The base station is a radio access network network device. Usually, the network in the related art configures corresponding capability information for each network element through a network management function. Therefore, one way is that the network management function provides the configured sensing capability information of the base station to NRF and/or SF. Another way is that the network element can register its supported capability information to NRF and/or AMF and/or SF, so that other network elements can perform network element selection and network element service discovery. Therefore, when the first device is a base station, a potential interaction procedure of sensing capability includes the following steps:
Step 1: A base station sends sensing capability information to an AMF through an N2 interface, where the sensing capability information of the base station can be reported in a cell list manner.

An example is as follows:
(a) Cell1: cell identifier, sensing capability parameter list. Potential parameters include at least one of the sensing capability information in the foregoing 1 to 18, which will not be combined and described one by one.
Parameter 1 sensing protocol (0 indicates that a sensing protocol between a base station and a core network function is not supported, and 1 indicates that a sensing protocol between a base station and a core network function is supported).
Parameter 2 base station monostatic sensing (0 indicates that base station monostatic sensing or echo sensing is not supported, and 1 indicates that base station monostatic sensing or echo sensing is supported).
(b) Cell2: cell identifier, sensing capability parameter list.
Parameter 1 sensing protocol (0 indicates that a sensing protocol between a base station and a core network function is not supported, and 1 indicates that a sensing protocol between a base station and a core network function is supported).
Parameter 2 base station monostatic sensing (0 indicates that base station monostatic sensing or echo sensing is not supported, and 1 indicates that base station monostatic sensing or echo sensing is supported).
Step 2: After the AMF receives the sensing capability information of the base station, one way is to store and use the sensing capability information of the base station by the AMF, another way is to register the sensing capability information of the base station to NRF via the AMF; or the AMF sends the sensing capability information of the base station to an SF of a corresponding area.
Step 3: An AF sends a sensing requirement to a mobile network function NEF.
Step 4: After receiving the sensing requirement of the AF, the NEF selects an appropriate AMF.
(a) If the sensing capability information of the base station is stored by the AMF, the AMF requests registered SF information from NRF, selects an appropriate SF and an appropriate base station, and sends a sensing request and a selected cell list (including one or more cell identifiers) to the SF. The sensing request includes one or more of the following information:
sensing target area: refers to an area where a sensing object may exist, or a position area that needs imaging or three-dimensional reconstruction;
sensing object type: classifying sensing objects based on possible motion characteristics of sensing objects, each sensing object type including typical motion speed, motion acceleration, and typical RCS of sensing objects;
sensing target object: during performing sensing on one or more sensing target objects, providing identification information of the sensing objects, where potential identification methods include: feature identification on distance, speed, angle spectrum, or network identifiable UE ID; and
sensing QoS: performance indicators for sensing a sensing target area or sensing object, including at least one of the following: sensing resolution (further may be divided into: ranging resolution, angle measurement resolution, speed measurement resolution, and imaging resolution), sensing accuracy (further may be divided into: ranging accuracy, angle measurement accuracy, speed measurement accuracy, and positioning accuracy), sensing range (further may be divided into: ranging range, speed measurement range, angle measurement range, and imaging range), sensing delay (time interval from sending a sensing signal to obtaining a sensing result, or time interval from initiating a sensing requirement to obtaining a sensing result), sensing update rate (time interval between two adjacent executions of sensing and obtaining sensing results), detection probability (probability of being correctly detected when a sensing object exists), and false alarm probability (probability of erroneously detecting a sensing target when a sensing object does not exist).
(b) If the sensing capability information of the base station is stored by NRF, it may also be that the AMF requests registered SF information from NRF, selects an appropriate SF, and sends a sensing request to the SF. The sensing request is as shown in option (a). The SF requests registered base station information from NRF, and the request of the SF may include at least one of sensing area, sensing object type, sensing target object type, and sensing QoS. The SF selects an appropriate base station and cell for sensing based on the obtained base station capability information.

The reporting procedure of the sensing capability of the first device as shown in Embodiments 1 and 2 may be actively (such as a registration request message from a UE to a network, an N2 message from a base station to a network) reporting sensing capability information; or may be that the first device only reports capability information of whether sensing is supported (that is, whether the first device supports a sensing protocol). Then a network function sends a sensing capability query message to the first device through a control plane or data plane as needed. The sensing capability query message includes a first device identifier and a sensing capability parameter indication. Optionally, when the first device is a base station, it may also include a cell identifier of the first device.

Embodiments 3 and 4 below describe the network function sending a sensing capability query message through a data plane.

### Embodiment 3

This embodiment is an interaction procedure of sensing capability based on a control plane and a data plane when the first device is a UE.

This embodiment considers the situation where a data plane is added in future 6G on the basis of the control plane and user plane of the relevant protocols. The data plane can be used to improve the efficiency of network data collection, data analysis, data storage, and data services, enhance data security/privacy, and support state/performance data collection and intra-network data transmission of network endogenous new services (such as data services and sensing services), and new requirements brought by network intelligence (such as AI model transmission and AI training data interaction).

As shown in Embodiment 1, the UE may provide only capability information of whether the UE supports sensing (that is, whether the UE supports a sensing protocol) through a registration request message in a registration procedure (Registration procedure). Then a core network network function (such as AMF, SF) determines whether to collect sensing capability information of the UE from a core network data plane function as needed. If collection is needed, the relevant process is briefly described as follows:
Step 1: One or more of network functions such as AMF, NRF, SF, or NEF send a data collection request to a core network data plane function, the data collection request including at least one of the following:
(a) UE 1: identifier, sensing capability parameter. The sensing capability parameter may include at least one of the sensing capability information in parameters 2 to 18 of the foregoing technical scheme according to protocol definition. Herein, one sensing capability parameter indication method is all 0 indicating default all reporting. Another indication method is to indicate a specific sensing parameter through a field predefined by the protocol, for example, the lowest bit of the field being 1 indicates reporting sensing service notification mechanism capability, being 0 indicates not reporting sensing service capability; the second bit of the field being 1 indicates reporting capability of sensing through a first-device-to-first-device interface, being 0 indicates not reporting capability of sensing through a first-device-to-first-device interface.
(b) UE 2: identifier, sensing capability parameter.
Step 2: The core data plane function merges the sensing capabilities in the received data collection requests of the network functions, and sends a data request to a corresponding UE, the data request including at least a data item that the UE needs to report.
Step 3: The UE sends required sensing capability information to the core network data plane function based on the received data request.
Step 4: The core network data plane function sends a data response based on the data collection requests of AMF, NRF, SF, or NEF, the data response including sensing capability data of the UE.

### Embodiment 4

This embodiment is an interaction procedure of sensing capability based on a data plane when the first device is a base station.

This embodiment considers the situation where a data plane is added in future 6G on the basis of the control plane and user plane of the relevant protocols. The data plane can be used to improve the efficiency of network data collection, data analysis, data storage, and data services, enhance data security/privacy, and support state/performance data collection and intra-network data transmission of network endogenous new services (such as data services and sensing services), and new requirements brought by network intelligence (such as AI model transmission and AI training data interaction).

Since sensing capability is not closely related to communication transmission on the control plane and user plane in the related art, in this embodiment, the sensing capability of the base station is directly collected through a core network data plane function, without relaying through AMF. Potential network functions requiring base station sensing capability may be one or more of SF, AMF, NRF, NEF, then the relevant process is briefly described as follows:
Step 1: One or more of network functions such as AMF, NRF, SF, NEF send a data collection request to a core network data plane function.
(a) A data collection request includes a sensing area and a sensing capability parameter. The sensing area is used to determine a base station that needs to report sensing capability data; and the sensing capability parameter may include at least one of the sensing capabilities in parameters 1 to 18 of the foregoing technical scheme according to protocol definition. Herein, one sensing capability parameter indication method is all 0 indicating default all reporting. Another indication method is to indicate a specific sensing parameter through a field predefined by the protocol, for example, the lowest bit of the field being 1 indicates reporting sensing service notification mechanism capability, being 0 indicates not reporting sensing service capability; the second bit of the field being 1 indicates reporting capability of sensing through a first-device-to-first-device interface, being 0 indicates not reporting capability of sensing through a first-device-to-first-device interface. The data collection request includes at least one of the following:
(b) A data collection request includes a radio access network device identifier (such as gNB ID, Global gNB ID in 5G) and a sensing capability parameter (see the description in (a)).
(c) A data collection request includes a cell identifier and a sensing capability parameter (see the description in (a)).
Step 2: The core data plane function merges the sensing capabilities in the received data collection requests of the network functions, and sends a data request to a corresponding radio access network network node (such as gNB) or cell, the data request including at least a data item that the base station or cell needs to report.
Step 3: The base station or cell sends required sensing capability information to the core network data plane function based on the received data request.
Step 4: The core network data plane function sends a data response based on the data collection requests of AMF, NRF, SF, or NEF, the data response including sensing capability information of the base station or cell.

The method for reporting sensing capability provided in the embodiments of this application, the execution subject may be an apparatus for reporting sensing capability. In the embodiments of this application, the apparatus for reporting sensing capability performing the method for reporting sensing capability is taken as an example to illustrate the apparatus for reporting sensing capability provided in the embodiments of this application.

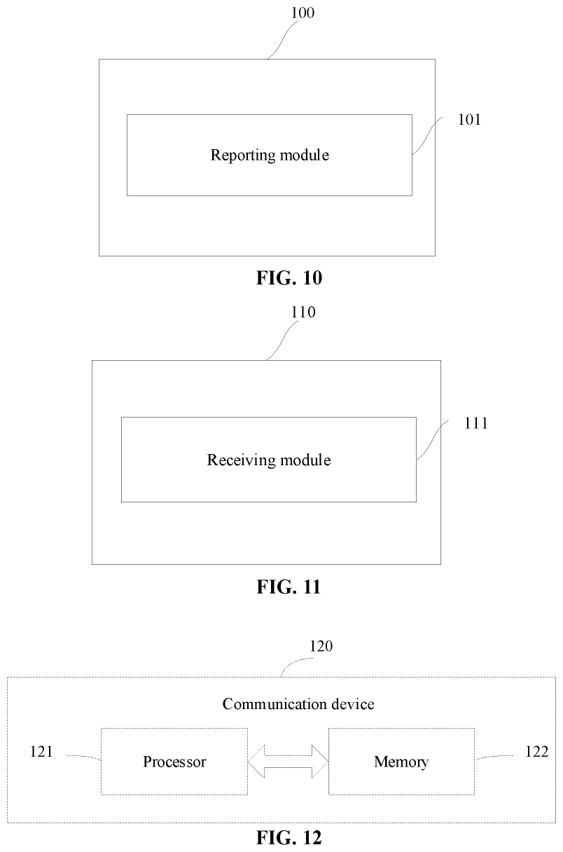

Referring to FIG. 10, an embodiment of this application further provides an apparatus 100 for reporting sensing capability, including:
a reporting module 101, configured to report sensing capability information of a first device;
where the sensing capability information is used to indicate at least one of the following:
capability of whether a sensing protocol is supported;
capability of whether receiving sensing service notification is supported;
capability of whether sensing through a first-device-to-first-device interface is supported;
capability of whether monostatic sensing is supported;
capability of whether sensing through a first-device-to-second-device interface is supported, the second device being of a different type from the first device;
capability of whether sending a sensing signal is supported;
capability of whether receiving or measuring a sensing signal is supported;
capability of whether providing sensing assistance information is supported;
sensing data processing capability;
capability of whether a target sensing mode is supported;
capability of whether sensing based on at least two target radio access technologies is supported;
capability of whether receiving a sensing request sent by a target device is supported;
capability of whether an application function selecting the first device to participate in sensing is supported;
capability of whether a target sensing scrambling algorithm is supported;
capability of whether a target sensing fuzzification algorithm is supported;
supported sensing resolution;
supported sensing accuracy; and
supported sensing service range.

Optionally, the capability of whether a sensing protocol is supported includes at least one of the following:
capability of whether a sensing protocol in a 4G control plane interface mode is supported;
capability of whether a sensing protocol in a 5G control plane interface mode is supported;
capability of whether a sensing protocol in a 5G user plane interface mode is supported;
capability of whether a sensing protocol in a 6G control plane interface mode is supported;
capability of whether a sensing protocol in a 6G user plane interface mode is supported;
capability of whether a sensing protocol in a 6G data plane interface mode is supported;
capability of whether a sensing protocol in a 4G first-device-to-first-device interface mode is supported;
capability of whether a sensing protocol in a 5G first-device-to-first-device interface mode is supported; and
capability of whether a sensing protocol in a 6G first-device-to-first-device interface mode is supported.

Optionally, the sensing service notification includes: whether a privacy check is required for a sensing request.

Optionally, the sensing service notification further includes: identity information of a sensing service client corresponding to the sensing request, or a service type corresponding to the sensing request.

Optionally, the capability of whether sensing through a first-device-to-first-device interface is supported includes at least one of the following:
capability of whether sensing through a 4G first-device-to-first-device interface is supported;
capability of whether sensing through a 5G first-device-to-first-device interface is supported; and
capability of whether sensing through a 6G first-device-to-first-device interface is supported.

Optionally, the first device is a base station, the first-device-to-first-device interface is a base station-to-base station radio interface.

Optionally, the capability of whether monostatic sensing is supported includes at least one of the following:
capability of whether monostatic sensing based on a 4G protocol is supported;
capability of whether monostatic sensing based on a 5G protocol is supported; and
capability of whether monostatic sensing based on a 6G protocol is supported.

Optionally, the capability of whether sensing through a first-device-to-second-device interface is supported includes at least one of the following:
capability of whether sensing through the first device sending a sensing signal and the second device receiving the sensing signal is supported; and
capability of whether sensing through the first device receiving a sensing signal and the second device sending the sensing signal is supported.

Optionally, the sensing data processing capability includes at least one of the following: capability of whether sensing data processing, level information of sensing data processing complexity, level information of sensing data computing capability, and level information of sensing data storage capability are supported.

Optionally, the target sensing mode includes at least one of the following:
a base station sending a sensing signal and a terminal receiving the sensing signal, the first device being the base station or the terminal;
a base station performing self-sending and self-receiving of a sensing signal, the first device being the base station;
a first base station sending a sensing signal and a second base station receiving the sensing signal, the first device being the first base station or the second base station;
a terminal sending a sensing signal and a base station receiving the sensing signal, the first device being the base station or the terminal;
a terminal performing self-sending and self-receiving of a sensing signal, the first device being the terminal; and
a first terminal sending a sensing signal and a second terminal receiving the sensing signal, the first device being the first terminal or the second terminal.

Optionally, the capability of whether sensing based on at least two target radio access technologies is supported includes at least one of the following:
capability of whether the following is supported: the first device sending sensing data to a second device based on a first access technology, the sensing data including: sensing data obtained by the first device based on a second access technology;
capability of whether the following is supported: the first device receiving sensing configuration information from a second device based on a first access technology, the sensing configuration information being used to configure sensing of the first device based on a second access technology;
capability of whether the following is supported: the first device sending a sensing signal based on a first access technology and receiving a sensing signal based on a second access technology;
capability of whether the following is supported: the first device sending a sensing signal based on a first access technology and sending a sensing signal based on a second access technology; and
capability of whether the following is supported: the first device receiving a sensing signal based on a first access technology and receiving a sensing signal based on a second access technology.

Optionally, the target device includes at least one of the following:
an application function;
a network function, the network function including a radio access network function or a core network function; and
a terminal.

Optionally, the first device is a transmitter of a sensing signal, and the capability of whether a target sensing scrambling algorithm is supported includes: scrambling the sensing signal using a scrambling sequence.

Optionally, the first device is a receiver of a sensing signal, and the capability of whether a target sensing scrambling algorithm is supported includes: determining a scrambling sequence, and descrambling a received sensing signal based on the scrambling sequence.

Optionally, the scrambling sequence is determined based on first information, the first information including at least one of the following:
sensing area identifier;
identifier of whether used for sensing;
sensing service identifier;
sensing service type identifier;
sensing target identifier;
tag identifier associated with a sensing target;
device identifier participating in sensing measurement;
time domain resource or frequency domain resource information used for sensing; and codeword number.

Optionally, the scrambling sequence includes at least one of the following:
pseudo-random PN sequence, an initial value of the PN sequence being associated with the first information;
ZC sequence, a root sequence number or cyclic shift value of the ZC sequence being associated with the first information; and
linear frequency modulation Chirp signal or frequency modulation continuous wave FMCW signal, a frequency modulation slope or starting frequency of the Chirp signal or FMCW signal being associated with the first information.

Optionally, the capability of whether a target sensing fuzzification algorithm is supported includes at least one of the following:
adding random noise to sensing measurement data;
adding random noise to sensing measurement data before coordinate transformation of the sensing measurement data, the coordinate transformation including at least one of the following: transforming from polar coordinate system to rectangular coordinate system, and transforming from rectangular coordinate system to polar coordinate system;
adding random noise to Kalman filtered sensing measurement data; and
after performing state prediction on sensing measurement data, adding random noise to a state prediction result.

Optionally, the sensing resolution includes at least one of the following:
distance resolution;
delay resolution;
angle resolution;
speed resolution; and
Doppler resolution.

Optionally, the sensing accuracy includes at least one of the following:
distance error;
delay error;
angle error;
speed error;
Doppler error;
detection probability;
false alarm probability; and
recognition accuracy rate.

Optionally, the first device is a terminal, and the first device reports the sensing capability information of the first device through a registration request message.

Optionally, the first device is a terminal, and the sensing capability information is contained in a terminal mobility management core network capability.

Optionally, the first device is a base station, and the first device reports the sensing capability information of the first device through an N2 message.

Optionally, the first device is a base station, and the first device reports the sensing capability information of the first device through a cell list, the cell list including at least one cell of the first device and the sensing capability information corresponding to each cell.

Optionally, the reporting module 101 is configured to: receive sensing capability query information, the sensing capability query information including: an identifier of the first device or a cell identifier of the first device, and information of a sensing capability that needs to be queried; and report, based on the sensing capability query information, the sensing capability information that needs to be queried.

Optionally, the reporting module 101 is configured to actively report capability of supporting a sensing protocol.

Optionally, the sensing capability query information is sent through a data collection request on a data plane.

The apparatus for reporting sensing capability in the embodiments of this application may be an electronic device, for example, an electronic device with an operating system, or may be a component in an electronic device, for example, an integrated circuit or a chip. The electronic device may be a terminal, or may be other devices besides a terminal. Exemplarily, the terminal may include but is not limited to the types of the terminal 11 listed above, and other devices may be servers, network attached storage (NAS), or the like, which are not specifically limited in the embodiments of this application.

The apparatus for reporting sensing capability provided in the embodiments of this application can implement the processes implemented by the method embodiment of FIG. 2, with the same technical effects achieved. To avoid repetition, details are not described herein again.

The method for receiving sensing capability provided in the embodiments of this application, the execution subject may be an apparatus for receiving sensing capability. In the embodiments of this application, the apparatus for receiving sensing capability performing the method for receiving sensing capability is taken as an example to illustrate the apparatus for receiving sensing capability provided in the embodiments of this application.

Referring to FIG. 11, an embodiment of this application further provides an apparatus 110 for receiving sensing capability, including:
a receiving module 111, configured to receive sensing capability information of a first device;
where the sensing capability information is used to indicate at least one of the following:
capability of whether a sensing protocol is supported;
capability of whether receiving sensing service notification is supported;
capability of whether sensing through a first-device-to-first-device interface is supported;
capability of whether monostatic sensing is supported;
capability of whether sensing through a first-device-to-second-device interface is supported, the second device being of a different type from the first device;
capability of whether sending a sensing signal is supported;
capability of whether receiving or measuring a sensing signal is supported;
capability of whether providing sensing assistance information is supported;
sensing data processing capability;
capability of whether a target sensing mode is supported;
capability of whether sensing based on at least two target radio access technologies is supported;
capability of whether receiving a sensing request sent by a target device is supported;
capability of whether an application function selecting the first device to participate in sensing is supported;
capability of whether a target sensing scrambling algorithm is supported;
capability of whether a target sensing fuzzification algorithm is supported;
supported sensing resolution;
supported sensing accuracy; and
supported sensing service range.

Optionally, the apparatus 110 for receiving sensing capability further includes: a selection module, configured to select, based on the sensing capability information of the first device, a target first device to participate in sensing.

The apparatus for receiving sensing capability in the embodiments of this application may be an electronic device, for example, an electronic device with an operating system, or may be a component in an electronic device, for example, an integrated circuit or a chip.

The apparatus for reporting sensing capability provided in the embodiments of this application can implement the processes implemented by the method embodiment of FIG. 6, with the same technical effects achieved. To avoid repetition, details are not described herein again.

As shown in FIG. 12, an embodiment of this application further provides a communication device 120, including a processor 121 and a memory 122, where the memory 122 stores a program or instructions executable on the processor 121. for example, when the communication device 120 is a first device, the program or instructions, when executed by the processor 121, implement the steps of the above embodiments of the method for reporting sensing capability, with the same technical effects achieved. When the communication device 120 is a third device, the program or instructions, when executed by the processor 121, implement the steps of the above embodiments of the method for receiving sensing capability, with the same technical effects achieved. To avoid repetition, details are not described herein again.

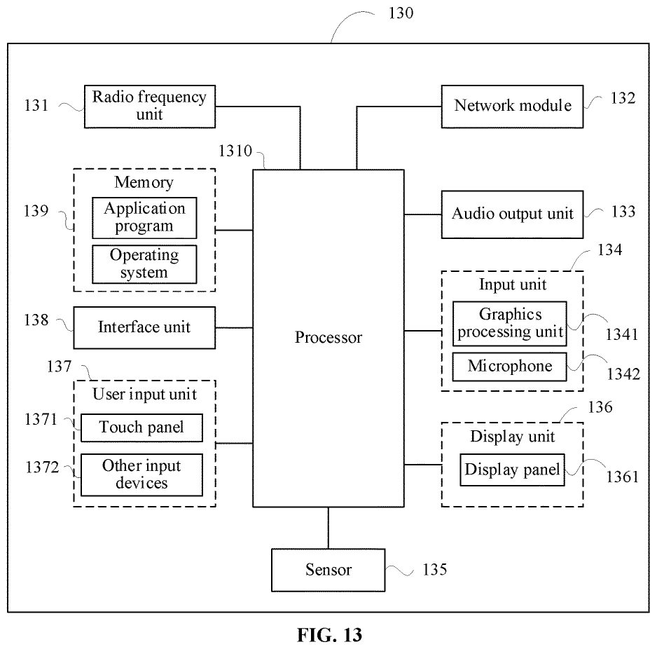

An embodiment of this application further provides a terminal, including a processor and a communication interface, where the communication interface is coupled to the processor, the processor is configured to run a program or instructions to implement the steps of the method embodiment shown in FIG. 2. This terminal embodiment corresponds to the above terminal side method embodiment, and each implementation process and implementation of the above method embodiment can be applied to this terminal embodiment, with the same technical effects achieved. Specifically, FIG. 13 is a schematic hardware structural diagram of a terminal implementing an embodiment of this application.

The terminal 130 includes but is not limited to at least some of components such as a radio frequency unit 131, a network module 132, an audio output unit 133, an input unit 134, a sensor 135, a display unit 136, a user input unit 137, an interface unit 138, a memory 139, and a processor 1310.

Persons skilled in the art can understand that the terminal 130 may further include a power supply (for example, a battery) for supplying power to the components. The power supply may be logically connected to the processor 1310 through a power management system. In this way, functions such as charge management, discharge management, and power consumption management are implemented by using the power management system. The structure of the terminal shown in FIG. 13 does not constitute any limitation on the terminal. The terminal may include more or fewer components than shown in the figure, or a combination of some components, or the components disposed differently. Details are not described herein again.

It should be understood that in this embodiment of this application, the input unit 134 may include a graphics processing unit (GPU) 1341 and a microphone 1342. The graphics processing unit 1341 processes image data of a static picture or a video that is obtained by an image capture apparatus (for example, a camera) in a video capture mode or an image capture mode. The display unit 136 may include a display panel 1361, and the display panel 1361 may be configured in a form of a liquid crystal display, an organic light-emitting diode, and the like. The user input unit 137 includes at least one of a touch panel 1371 and other input devices 1372. The touch panel 1371 is also referred to as a touchscreen. The touch panel 1371 may include two parts: a touch detection apparatus and a touch controller. The other input devices 1372 may include but are not limited to a physical keyboard, a function key (for example, a volume control key or a power on/off key), a trackball, a mouse, a joystick, and the like. Details are not described herein.

In this embodiment, after receiving downlink data from a network-side device, the radio frequency unit 131 may transmit the downlink data to the processor 1310 for processing. In addition, the radio frequency unit 131 may transmit uplink data to the network-side device. Generally, the radio frequency unit 131 includes but is not limited to an antenna, an amplifier, a transceiver, a coupler, a low noise amplifier, and a duplexer.

The memory 139 may be configured to store software programs or instructions and various data. The memory 139 may include first storage area for storing programs or instructions and a second storage area for storing data. The first storage area may store an operating system, an application program or instruction required by at least one function (for example, a sound playback function or an image playback function), and the like. In addition, the memory 139 may include a volatile memory or a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), a static random access memory (SRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synchronous link dynamic random access memory (SLDRAM), and a direct rambus random access memory (DRRAM). The memory 139 in this embodiment of this application includes but is not limited to these and any other suitable types of memories.

The processor 1310 may include one or more processing units. Optionally, an application processor and a modem processor are integrated in the processor 1310. The application processor primarily processes operations relating to an operating system, user interfaces, application programs, and the like. The modem processor primarily processes radio communication signals, for example, being a baseband processor. It can be understood that the modem processor may alternatively be not integrated in the processor 1310.

The radio frequency unit 131 is configured to report sensing capability information of the first device;
where the sensing capability information is used to indicate at least one of the following:
capability of whether a sensing protocol is supported;
capability of whether receiving sensing service notification is supported;
capability of whether sensing through a first-device-to-first-device interface is supported;
capability of whether monostatic sensing is supported;
capability of whether sensing through a first-device-to-second-device interface is supported, the second device being of a different type from the first device;
capability of whether sending a sensing signal is supported;
capability of whether receiving or measuring a sensing signal is supported;
capability of whether providing sensing assistance information is supported;
sensing data processing capability;
capability of whether a target sensing mode is supported;
capability of whether sensing based on at least two target radio access technologies is supported;
capability of whether receiving a sensing request sent by a target device is supported;
capability of whether an application function selecting the first device to participate in sensing is supported;
capability of whether a target sensing scrambling algorithm is supported;
capability of whether a target sensing fuzzification algorithm is supported;
supported sensing resolution;
supported sensing accuracy; and
supported sensing service range.

It can be understood that the implementation processes of each implementation mentioned in this embodiment can refer to the relevant descriptions of the above embodiments of the method for reporting sensing capability, with the same or corresponding technical effects achieved. To avoid repetition, details are not described herein again.

An embodiment of this application further provides a network-side device, including a processor and a communication interface, where the communication interface is coupled to the processor, and the processor is configured to run a program or instructions to implement the steps of the method embodiment shown in FIG. 2 or FIG. 6. The network-side device embodiment corresponds to the foregoing network-side device method embodiment. All implementations in the foregoing method embodiment may be applicable to the network-side device embodiment, with the same technical effects achieved.

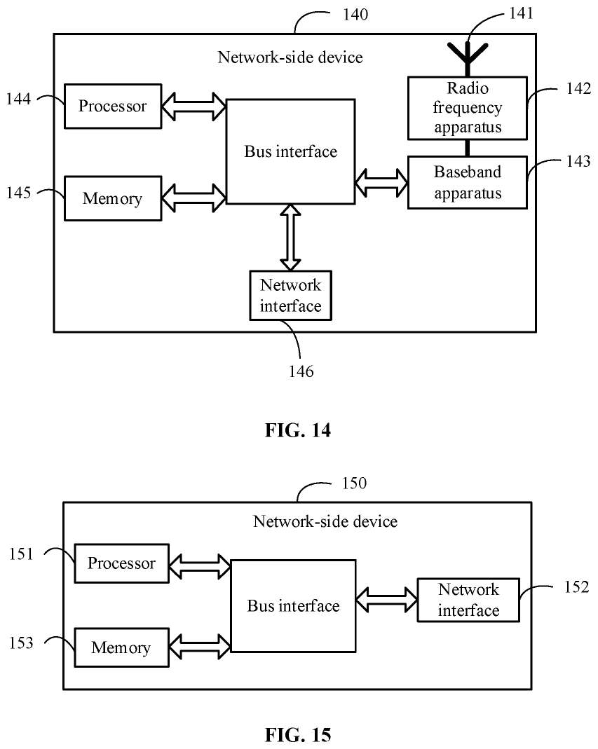

Specifically, an embodiment of this application further provides a network-side device. As shown in FIG. 14, the network-side device 140 includes: an antenna 141, a radio frequency apparatus 142, a baseband apparatus 143, a processor 144, and a memory 145. The antenna 141 is connected to the radio frequency apparatus 142. In an uplink direction, the radio frequency apparatus 142 receives information through the antenna 141, and sends the received information to the baseband apparatus 143 for processing. In a downlink direction, the baseband apparatus 143 processes to-be-sent information, and sends the information to the radio frequency apparatus 142; and the radio frequency apparatus 142 processes the received information and then sends the information using the antenna 141.

The method performed by the network-side device in the foregoing embodiment may be implemented in the baseband apparatus 143, and the baseband apparatus 143 includes a baseband processor.

The baseband apparatus 143 may include, for example, at least one baseband board, where a plurality of chips are disposed on the baseband board. As shown in FIG. 14, one of the chips is, for example, the baseband processor, and connected to the memory 145 through a bus interface, to invoke the program in the memory 145 to perform the operations of the network device shown in the foregoing method embodiment.

The network-side device may further include a network interface 146, where the interface is, for example, a common public radio interface (CPRI).

Specifically, the network-side device 140 in this embodiment of this application further includes: instructions or a program stored in the memory 145 and capable of running on the processor 144. The processor 144 invokes the instructions or program in the memory 145 to execute the method executed by the modules shown in FIG. 10 or FIG. 11, with the same technical effects achieved. To avoid repetition, details are not described herein again.

Specifically, an embodiment of this application further provides a network-side device. As shown in FIG. 15, the network-side device 150 includes a processor 151, a network interface 152, a memory 153. The network interface 152 may be, for example, a common public radio interface (CPRI).

Specifically, the network-side device 150 in this embodiment of this application further includes: instructions or a program stored in the memory 153 and capable of running on the processor 151. The processor 151 invokes the instructions or program in the memory 153 to execute the method executed by the modules shown in FIG. 11, with the same technical effects achieved. To avoid repetition, details are not described herein again.

An embodiment of this application further provides a readable storage medium, where the readable storage medium stores a program or instructions, and the program or instructions, when executed by a processor, implement each process of the above embodiments of the method for reporting sensing capability or the method for receiving sensing capability, with the same technical effects achieved. To avoid repetition, details are not described herein again.

The processor is a processor in the terminal described in the foregoing embodiment. The readable storage medium includes a computer-readable storage medium such as a computer read-only memory ROM, a random access memory RAM, a magnetic disk, or an optical disc. In some examples, the readable storage medium may be a non-transitory readable storage medium.

An embodiment of this application further provides a chip, where the chip includes a processor and a communication interface, the communication interface is coupled to the processor, the processor is configured to run a program or instructions to implement the processes of the above embodiments of the method for reporting sensing capability or the method for receiving sensing capability, with the same technical effects achieved. To avoid repetition, details are not described herein again.

It should be understood that the chip mentioned in the embodiments of this application may also be referred to as a system-level chip, a system chip, a chip system, or a system-on-chip chip.

An embodiment of this application further provides a computer program/program product, where the computer program/program product is stored in a storage medium, and the computer program/program product is executed by at least one processor to implement the processes of the above embodiments of the method for reporting sensing capability or the method for receiving sensing capability, with the same technical effects achieved. To avoid repetition, details are not described herein again.

An embodiment of this application further provides a communication system, including: a first device and a third device, where the first device is configured to perform the steps of the method for reporting sensing capability as described above, and the third device is configured to perform the steps of the method for receiving sensing capability as described above.

It should be noted that in this specification, the terms “include” and “comprise”, or any of their variants are intended to cover a non-exclusive inclusion, such that a process, method, article, or apparatus that includes a list of elements not only includes those elements but also includes other elements that are not expressly listed, or further includes elements inherent to such process, method, article, or apparatus. In absence of more constraints, an element preceded by “includes a . . . ” does not preclude the existence of other identical elements in the process, method, article, or apparatus that includes the element. Furthermore, it should be noted that the scope of the methods and apparatuses in the embodiments of this application is not limited to performing the functions in the order shown or discussed, but may also include performing the functions in a substantially simultaneous manner or in a reverse order depending on the functions involved. For example, the described methods may be performed in an order different from that described, and various steps may be added, omitted, or combined. In addition, features described with reference to some examples may be combined in other examples.

Through the description of the above embodiments, persons skilled in the art can clearly understand that the above embodiment methods can be implemented by means of a computer software product plus a necessary general hardware platform, and of course, may also be implemented by hardware. The computer software product is stored in a storage medium (such as ROM, RAM, magnetic disk, and optical disk), including several instructions to cause a terminal or network-side device to perform the methods described in various embodiments of this application.

The embodiments of this application have been described above with reference to the accompanying drawings. However, this application is not limited to the above specific embodiments, which are merely illustrative rather than restrictive.

1. A method for reporting sensing capability, comprising:
reporting, by a first device, sensing capability information of the first device;
wherein the sensing capability information is used to indicate at least one of the following:
capability of whether a sensing protocol is supported;
capability of whether receiving sensing service notification is supported;
capability of whether sensing through a first-device-to-first-device interface is supported;
capability of whether monostatic sensing is supported;
capability of whether sensing through a first-device-to-second-device interface is supported, the second device being of a different type from the first device;
capability of whether sending a sensing signal is supported;
capability of whether receiving a sensing signal or measuring a sensing signal is supported;
capability of whether providing sensing assistance information is supported;
sensing data processing capability;
capability of whether a target sensing mode is supported;
capability of whether sensing based on at least two target radio access technologies is supported;
capability of whether receiving a sensing request sent by a target device is supported;
capability of whether an application function selecting the first device to participate in sensing is supported;
capability of whether a target sensing scrambling algorithm is supported;
capability of whether a target sensing fuzzification algorithm is supported;
supported sensing resolution;
supported sensing accuracy; or
supported sensing service range.

2. The method according to claim 1, wherein the capability of whether a sensing protocol is supported comprises at least one of the following:
capability of whether a sensing protocol in a 4G control plane interface mode is supported;
capability of whether a sensing protocol in a 5G control plane interface mode is supported;
capability of whether a sensing protocol in a 5G user plane interface mode is supported;
capability of whether a sensing protocol in a 6G control plane interface mode is supported;
capability of whether a sensing protocol in a 6G user plane interface mode is supported;
capability of whether a sensing protocol in a 6G data plane interface mode is supported;
capability of whether a sensing protocol in a 4G first-device-to-first-device interface mode is supported;
capability of whether a sensing protocol in a 5G first-device-to-first-device interface mode is supported; or
capability of whether a sensing protocol in a 6G first-device-to-first-device interface mode is supported.

3. The method according to claim 1, wherein the sensing service notification comprises: whether privacy check is required for a sensing request.

4. The method according to claim 1, wherein the sensing service notification further comprises: identity information of a sensing service client corresponding to the sensing request, or a service type corresponding to the sensing request.

5. The method according to claim 1, wherein the capability of whether sensing through a first-device-to-first-device interface is supported comprises at least one of the following:
capability of whether sensing through a 4G first-device-to-first-device interface is supported;
capability of whether sensing through a 5G first-device-to-first-device interface is supported; or
capability of whether sensing through a 6G first-device-to-first-device interface is supported.

6. The method according to claim 1, wherein the first device is a base station, the first-device-to-first-device interface is a radio interface between a base station and a base station.

7. The method according to claim 1, wherein the capability of whether monostatic sensing is supported comprises at least one of the following:
capability of whether monostatic sensing based on a 4G protocol is supported;
capability of whether monostatic sensing based on a 5G protocol is supported; or
capability of whether monostatic sensing based on a 6G protocol is supported.

8. The method according to claim 1, wherein the capability of whether sensing through a first-device-to-second-device interface is supported comprises at least one of the following:
capability of whether sensing through the first device sending a sensing signal and the second device receiving the sensing signal is supported; or
capability of whether sensing through the first device receiving a sensing signal and the second device sending the sensing signal is supported.

9. The method according to claim 1, wherein the sensing data processing capability comprises at least one of the following: capability of whether sensing data processing is supported, level information of sensing data processing complexity, level information of sensing data computing capability, or level information of sensing data storage capability are supported;
or
wherein the target sensing mode comprises at least one of the following:
a base station sending a sensing signal and a terminal receiving the sensing signal, the first device being the base station or the terminal;
a base station performing ending and receiving of a sensing signal, the first device being the base station;
a first base station sending a sensing signal and a second base station receiving the sensing signal, the first device being the first base station or the second base station;
a terminal sending a sensing signal and a base station receiving the sensing signal, the first device being the base station or the terminal;
a terminal performing sending and receiving of a sensing signal, the first device being the terminal: or
a first terminal sending a sensing signal and a second terminal receiving the sensing signal, the first device being the first terminal or the second terminal.

10. (canceled)

11. The method according to claim 1, wherein the capability of whether sensing based on at least two target radio access technologies is supported comprises at least one of the following:
capability of whether the following is supported: the first device sending sensing data to a second device based on a first access technology, the sensing data comprising: sensing data obtained by the first device based on a second access technology;
capability of whether the following is supported: the first device receiving sensing configuration information from a second device based on a first access technology, the sensing configuration information being used to configure sensing of the first device based on a second access technology;
capability of whether the following is supported: the first device sending a sensing signal based on a first access technology and receiving a sensing signal based on a second access technology;
capability of whether the following is supported: the first device sending a sensing signal based on a first access technology and sending a sensing signal based on a second access technology; or
capability of whether the following is supported: the first device receiving a sensing signal based on a first access technology and receiving a sensing signal based on a second access technology;
or
wherein the target device comprises at least one of the following:
an application function;
a network function, the network function comprising a radio access network function or a core network function; or
a terminal.

12. (canceled)

13. The method according to claim 1, wherein the first device is a transmitter of a sensing signal, and the capability of whether a target sensing scrambling algorithm is supported comprises: scrambling the sensing signal using a scrambling sequence;
or
wherein the first device is a receiver of a sensing signal, and the capability of whether a target sensing scrambling algorithm is supported comprises: determining a scrambling sequence, and descrambling a received sensing signal based on the scrambling sequence.

14. (canceled)

15. The method according to claim 13, wherein the scrambling sequence is determined based on first information, the first information comprising at least one of the following:
sensing area identifier;
identifier of whether used for sensing;
sensing service identifier;
sensing service type identifier;
sensing target identifier;
tag identifier associated with a sensing target;
device identifier participating in sensing measurement;
time domain resource or frequency domain resource information used for sensing; or
codeword number;
wherein the scrambling sequence comprises at least one of the following:
pseudo-random (PN) sequence, an initial value of the PN sequence being associated with the first information;
ZC sequence, a root sequence number or cyclic shift value ofthe ZC sequence being associated with the first information: or
linear frequency modulation Chirp signal or frequency modulation continuous wave (FMCW) signal, a frequency modulation slope or starting frequency of the Chirp signal or FMCW signal being associated with the first information.

16. (canceled)

17. The method according to claim 1, wherein the capability of whether a target sensing fuzzification algorithm is supported comprises at least one of the following:
adding random noise to sensing measurement data;
adding random noise to sensing measurement data before coordinate transformation of the sensing measurement data, the coordinate transformation comprising at least one of the following: transforming from polar coordinate system to rectangular coordinate system, or transforming from rectangular coordinate system to polar coordinate system;
adding random noise to Kalman filtered sensing measurement data; or
after performing state prediction on sensing measurement data, adding random noise to a state prediction result;
or,
wherein the sensing resolution comprises at least one of the following:
distance resolution;
delay resolution;
angle resolution;
speed resolution; or
Doppler resolution;
or,
wherein the sensing accuracy comprises at least one of the following:
distance error;
delay error;
angle error;
speed error;
Doppler error;
detection probability;
false alarm probability; or
recognition accuracy rate.

18.-19. (canceled)

20. The method according to claim 1, wherein the first device is a terminal, and the first device reports the sensing capability information of the first device through a registration request message;
or,
wherein the first device is a terminal, and the sensing capability information is contained in a terminal mobility management core network capability;
or,
wherein the first device is a base station, and the first device reports the sensing capability information of the first device through an N2 message;
or,
wherein the first device is a base station, and the first device reports the sensing capability information of the first device through a cell list, the cell list comprising at least one cell of the first device and the sensing capability information corresponding to each cell.

21.-23. (canceled)

24. The method according to claim 1, wherein the reporting, by first device, sensing capability information of the first device comprises:
receiving, by the first device, sensing capability query information, the sensing capability query information comprising: an identifier of the first device or a cell identifier of the first device, and information of a sensing capability that needs to be queried; and
reporting, by the first device, the sensing capability information that needs to be queried based on the sensing capability query information.

25. The method according to claim 24, wherein before the receiving, by the first device, sensing capability query information, further comprising:
actively reporting, by the first device, capability of supporting a sensing protocol;
and/or,
wherein the sensing capability query information is sent through a data collection request on a data plane.

26. (canceled)

27. A method for receiving sensing capability, comprising:
receiving, by a third device, sensing capability information of a first device;
wherein the sensing capability information is used to indicate at least one of the following:
capability of whether a sensing protocol is supported;
capability of whether receiving sensing service notification is supported;
capability of whether sensing through a first-device-to-first-device interface is supported;
capability of whether monostatic sensing is supported;
capability of whether sensing through a first-device-to-second-device interface is supported, the second device being of a different type from the first device;
capability of whether sending a sensing signal is supported;
capability of whether receiving or measuring a sensing signal is supported;
capability of whether providing sensing assistance information is supported;
sensing data processing capability;
capability of whether a target sensing mode is supported;
capability of whether sensing based on at least two target radio access technologies is supported;
capability of whether receiving a sensing request sent by a target device is supported;
capability of whether an application function selecting the first device to participate in sensing is supported;
capability of whether a target sensing scrambling algorithm is supported;
capability of whether a target sensing fuzzification algorithm is supported;
supported sensing resolution;
supported sensing accuracy; or
supported sensing service range.

28. The method according to claim 27, wherein after the receiving, by a third device, sensing capability information of a first device, further comprising:
selecting, by the third device based on the sensing capability information of the first device, a target first device to participate in sensing.

29.-30. (canceled)

31. A communication device, comprising a processor and a memory, wherein the memory stores a program or instructions executable on the processor, wherein the program or instructions, when executed by the processor, cause the communication device to perform:
reporting sensing capability information of the first device;
wherein the sensing capability information is used to indicate at least one of the following:
capability of whether a sensing protocol is supported;
capability of whether receiving sensing service notification is supported;
capability of whether sensing through a first-device-to-first-device interface is supported;
capability of whether monostatic sensing is supported;
capability of whether sensing through a first-device-to-second-device interface is supported, the second device being of a different type from the first device;
capability of whether sending a sensing signal is supported;
capability of whether receiving a sensing signal or measuring a sensing signal is supported;
capability of whether providing sensing assistance information is supported;
sensing data processing capability;
capability of whether a target sensing mode is supported;
capability of whether sensing based on at least two target radio access technologies is supported;
capability of whether receiving a sensing request sent by a target device is supported;
capability of whether an application function selecting the first device to participate in sensing is supported;
capability of whether a target sensing scrambling algorithm is supported;
capability of whether a target sensing fuzzification algorithm is supported;
supported sensing resolution;
supported sensing accuracy; or
supported sensing service range.

32. (canceled)

33. A communication device, comprising a processor and a memory, wherein the memory stores a program or instructions executable on the processor, and the program or instructions, when executed by the processor, implement the steps of the method for receiving sensing capability according to claim 27.
